(19) United States
(12) Patent Application Publication
(10) Pub. No.: US 2019/0305971 A1
(43) Pub. Date: Oct. 3, 2019

(54) PHYSICALLY UNCLONABLE FUNCTION (PUF) MEMORY EMPLOYING STATIC RANDOM ACCESS MEMORY (SRAM) BIT CELLS ENHANCED BY STRESS FOR INCREASED PUF OUTPUT REPRODUCIBILITY

(71) Applicant: QUALCOMM Incorporated, San Diego, CA (US)

(72) Inventors: Xia Li, San Diego, CA (US); Xiao Lu, San Diego, CA (US); Seung Hyuk Kang, San Diego, CA (US)

(21) Appl. No.: 15/944,089

(22) Filed: Apr. 3, 2018

(51) Int. Cl. H04L 9/32; G11C 11/419; G11C 7/12

(52) U.S. Cl. CPC H04L 9/3278; H04L 2209/12; G11C 7/12; G11C 11/419

(57) ABSTRACT

Physically unclonable function (PUF) memory employing static random access memory (SRAM) bit cells enhanced by stress for increased PUF output reproducibility. Stress voltage applied to SRAM bit cells enhances their skew so that the SRAM bit cells output their preferred initial state in subsequent PUF read operations regardless of process variation and other external environmental variations, such as temperature. The application of stress voltage on the SRAM bit cells in a PUF memory array takes advantage of the recognition of aging effect in transistors, where turning transistors on and off over time can increase threshold voltage resulting in lower drive current. Stress voltage can be applied to the SRAM bit cells to bias their threshold voltage to simulate this aging effect to enhance mismatch between transistors in the SRAM bit cell to more fully skew the SRAM bit cells for increased PUF output reproducibility with less susceptible to noise.

### BACKGROUND

### I. Field of the Disclosure

The technology of the disclosure relates generally to physically unclonable functions (PUFs), and more particularly to PUF circuits that include static random access memory (SRAM) bit cells for generating a random output as a function of skew in the SRAM bit cells.

### II. Background

A physical unclonable function (PUF) (also called a physically unclonable function (PUF)) is a physical entity that is embodied in a physical structure, and is easy to evaluate but hard to predict. PUFs depend on the uniqueness of their physical microstructure. This microstructure depends on random physical factors introduced during manufacturing. For example, in the context of integrated circuits (ICs), an on-chip PUF is a chip-unique challenge-response mechanism exploiting manufacturing process variations inside the ICs. These manufacturing process variations are unpredictable and uncontrollable, which makes it virtually impossible to duplicate or clone the structure. When a stimulus is applied to a PUF cell, the PUF cell reacts and generates a response in an unpredictable but repeatable way due to the complex interaction of the stimulus with the physical microstructure of the IC employing the PUF cell. This exact microstructure of the IC depends on physical factors introduced during its manufacture, which are unpredictable. The applied stimulus is called the “challenge,” and the reaction of the PUF cell is called the “response.” A specific challenge and its corresponding response together form a challenge-response pair (CRP) or challenge-response behavior. The PUF's “unclonability” means that each IC employing the PUF cell has a unique and unpredictable way of mapping challenges to responses, even if one IC is manufactured with the same process as another seemingly identical IC. Thus, it is practically infeasible to construct a PUF cell with the same challenge-response behavior as another IC's PUF cell, because exact control over the manufacturing process is infeasible.

Because it is practically infeasible to construct a PUF cell with the same challenge-response behavior as another PUF cell, a PUF cell can be included in an IC to generate unique, random information based on the underlying physical characteristics of a device. For example, information generated by the PUF cell may be used to authenticate a device or may be used as a cryptographic key. As another example, a mobile device may include circuitry that is configured to generate a PUF output for use as a basis for a device identifier of the device. The device identifier may be used as part of an authentication process with a server that is programmed with the device identifier.

PUF cells can be implemented in several different technologies. As an example, a PUF cell in a PUF circuit can be provided in the form of a static random access memory (SRAM) cell. For example, FIG. 1 illustrates a PUF cell 100 that includes an SRAM cell 102. The SRAM cell 102 is included in an SRAM bit cell 104. As shown therein, the SRAM cell 102 is comprised of two cross-coupled inverters 106(1), 106(2). Each inverter 106(1), 106(2) includes a pull-up P-type Field-Effect Transistor (FET) (PFET) 108P(1), 108P(2) coupled to a positive voltage rail 110P having a positive supply voltage V_{DD}, and a pull-down N-type FET (NFET) 108N(1), 108N(2) coupled to a negative voltage rail 110N having a negative supply voltage V_{SS}, which may be a lower voltage than the positive supply voltage V_{DD} or coupled to ground. The cross-coupled inverters 106(1), 106(2) reinforce each other to retain data in the form of a voltage on a respective true storage output T and a complement storage output C. In a read operation, a bit line BL and a complement bit line BLB are pre-charged to half the positive supply voltage V_{DD}. Then, a word line WL coupled to gates G of access transistors 112(1), 112(2) is asserted to evaluate differential voltages on the true storage output T and complement storage output C to read the SRAM bit cell 104. If the SRAM bit cell 104 has not been previously written, the initial state of the SRAM bit cell 104 is determined by process variation of the pull-up PFETs 108P(1), 108P(2) and the pull-down NFETs 108N(1), 108N(2) when the word line WL is asserted to activate the access transistors 112(1), 112(2) (their gate-to-source voltage exceeding their threshold voltage V_{TH}). Thus, the SRAM bit cell 104 can be used to generate a random PUF output. Either the true storage output T or complement storage output C can be used as the random PUF output. The voltage state (V_{DD} or V_{SS}) on the true storage output T will eventually settle to be the opposite voltage state on the complement storage output C (V_{SS} or V_{DD}).

Ideally, the inverters 106(1), 106(2) in the SRAM cell 102 in FIG. 1 will be symmetrically matched so that the SRAM cell 102 is not skewed to favor settling to one voltage state over the other. For example, length L and threshold voltage V_{TH} of complementary pull-up PFETs 108P(1), 108P(2) and complementary pull-down NFETs 108N(1), 108N(2) can be sized to generate a same voltage noise V_{NOISE}. As shown in FIG. 2A, ideally, the SRAM cell 102 in FIG. 1 has a neutral skew, wherein the inverters 106(1), 106(2) are symmetrically matched to generate a PUF output that is logic ‘0’ for approximately half of PUF read operations and logic ‘1’ for approximately the other half of the PUF read operations. However, process variations can cause the complementary pull-up PFETs 108P(1), 108P(2) and complementary pull-down NFETs 108N(1), 108N(2) in the inverters 106(1), 106(2) in the SRAM cell 102 in FIG. 1 to be mismatched, and thus be skewed towards one voltage state. This is shown by example in FIG. 2B. As shown in FIG. 2B, random noise σ_{NOISE} resulting from process variation Δ_{PV} skews the voltage state (i.e., neutral-skewed) of the SRAM cell 102 to always generate a logic ‘1’ PUF output.

Thus, the SRAM bit cell 104 in FIG. 1 can be used to provide PUF memory cells by taking advantage of this imbalance between the inverters 106(1), 106(2) in the SRAM cell 102 that will occur through process variation. A plurality of the SRAM bit cells 104 can be used to generate random X-bit numbers at power-up through a read operation, such as chip identifications for example. The SRAM bit cells 104 would be read and not written to first to obtain a random state at power-up. However, the reproducibility of the SRAM bit cells like the SRAM bit cell 104 in FIG. 1 may be so inconsistent that a huge redundant array and sophisticated error correction scheme may be required to implement a PUF in SRAM. The SRAM bit cell 104 also can suffer from high error rates between cycles, temperature, and supply power.

SRAM bit cells used as PUF cells, like the SRAM bit cell 104 in FIG. 1, should ideally provide reproducible outputs even under hostile conditions such as high temperature. Therefore, SRAM bit cells are classified depending upon the sensitivity to stress conditions. A non-skewed SRAM bit cell is an SRAM bit cell that has measurable mismatch between its two inverters. This does not mean process variations are not present in the SRAM bit cell, but that the combined effects of any process variations offset each other. A non-skewed SRAM bit cell randomly generates either a ‘0’ or ‘1’ as an output depending mainly upon noise present in the system. A skewed SRAM bit cell is an SRAM bit cell with some mismatch between its two inverters that do not offset each other. In this manner, skewed SRAM bit cells have a preferred state depending upon the nature of the mismatch. A skewed SRAM bit cell can flip and produce a different, inconsistently reproducible output due to variation of external conditions, such as temperature and noise. A fully-skewed SRAM bit cell is an SRAM bit cell that has a high mismatch between its two inverters in such a way that the SRAM bit cell always takes its preferred initial state regardless of the stress conditions. Ideally, the SRAM bit cells in an SRAM-based PUF circuit are fully-skewed so that the SRAM bit cells will produce a consistently reproducible output even with variations in external conditions such as temperature and noise. However, it typically cannot be guaranteed that all SRAM bit cells employed in an SRAM-based PUF circuit will be fully skewed, which will introduce some amount of inconsistency in the PUF circuit generating a reproducible output in an undesirable manner.

### SUMMARY OF THE DISCLOSURE

Aspects disclosed herein include physically unclonable function (PUF) memory employing static random access memory (SRAM) bit cells enhanced by stress for increased PUF output reproducibility. An SRAM circuit includes a PUF memory array that is comprised of one or more SRAM bit cells that are addressable to provide a PUF output in the form of a data bit/word output comprised of one or more data bits. In exemplary aspects disclosed herein, for the SRAM bit cells to consistently produce a reproducible PUF output, a stress voltage is applied to the SRAM bit cells to enhance their skew (e.g., mismatch of their cross-coupled inverters), thus outputting their preferred initial state in subsequent PUF read operations regardless of process variation and other external environmental variations, such as temperature and noise. The stress voltage can be applied to the SRAM bit cells during an initialization process for the PUF memory array. The application of stress voltage on the SRAM bit cells takes advantage of the recognition of the aging effect in transistors, where turning transistors on and off over time can increase their threshold voltage, thus weakening the transistors and lowering their drive current. Stress voltage can be applied to the SRAM bit cells to bias their threshold voltage to simulate the aging effect to enhance the mismatch between the transistors in the SRAM bit cells to more fully skew the SRAM bit cells for increased PUF output reproducibility. Thus, a PUF cell employing the stressed SRAM bit cells may be less susceptible to thermal noise which could otherwise cause bit flips if the SRAM bit cells were not sufficiently skewed. Also, in another example, stress on the SRAM bit cells in the PUF memory array may require the PUF memory array to consume less area and less power due to the increased reproducibility of the PUF output to allow a reduction in the complexity of error correction circuitry and a reduction in the number of bit cells provided in the PUF memory array to support error correction.

In further exemplary aspects disclosed herein, a statistical process (e.g., A Bayesian statistical process) can be used in an initialization process performed in the PUF memory array to determine the preferred skewed state of the SRAM bit cells therein. This determined preferred skewed state of the SRAM bit cells can then be used to apply stress voltage to the SRAM bit cells to further enhance the skew (e.g., by weakening certain transistors), thus increasing transistor mismatches (e.g., skew) for increased PUF output reproducibility.

In this regard, in one exemplary aspect, a PUF stress control circuit is provided. The PUF stress control circuit comprises a skew state decision circuit coupled to a PUF output of an SRAM. The SRAM comprises a PUF memory array comprising one or more SRAM bit cells. The SRAM is configured to generate a data output on the PUF output based on a memory state in at least one SRAM bit cell among the one or more SRAM bit cells accessed in a read operation to the PUF memory array. The skew state decision circuit is configured to receive the data output in response to the read operation to the accessed at least one SRAM bit cell in the PUF memory array. The skew state decision circuit is also configured to determine a logic state skew of the accessed at least one SRAM bit cell based on the data output. The PUF stress control circuit also comprises a stress control circuit coupled to the PUF memory array and the skew state decision circuit. The stress control circuit is configured to cause a stress voltage to be applied to the accessed at least one SRAM bit cell based on the determined logic state skew.

In another exemplary aspect, a PUF stress control circuit is provided. The PUF stress circuit comprises a means for skewing coupled to a PUF output of an SRAM comprising a PUF memory array comprising one or more SRAM bit cells. The SRAM is configured to generate a data output on the PUF output based on a memory state in at least one SRAM bit cell among the one or more SRAM bit cells accessed in a read operation to the PUF memory array. The means for skewing comprises a means for receiving the data output in response to the read operation to the accessed at least one SRAM bit cell in the PUF memory array. The means for skewing also comprises a means for determining a logic state skew of the accessed at least one SRAM bit cell based on the data output. The PUF stress control circuit also comprises a means for stressing for causing a stress voltage to be applied to the accessed at least one SRAM bit cell based on the means for determining the logic state skew of the accessed at least one SRAM bit cell.

In another exemplary aspect, a method of applying a stress to one or more SRAM bit cells in a PUF array is provided. The method comprises initiating a configuration read operation of a PUF memory array comprising one or more SRAM bit cells to receive a data output from a PUF output based on a memory state in at least one SRAM bit cell among the one or more SRAM bit cells accessed in the configuration read operation. The method also comprises determining a logic state skew of the accessed at least one SRAM bit cell based on the data output. The method also comprises causing a stress voltage to be applied to the accessed at least one SRAM bit cell based on the determined logic state skew.

In another exemplary aspect, a PUF memory is provided. The PUF memory comprises a PUF memory array. The PUF memory array comprises a plurality of PUF bit cell row circuits each comprising a plurality of SRAM bit cells. The PUF memory array also comprises a plurality of PUF bit cell column circuits each comprising an SRAM bit cell among the plurality of SRAM bit cells from an SRAM bit cell row circuit among the plurality of SRAM bit cell row circuits. The PUF memory comprises a PUF output coupled to the PUF memory array. The PUF memory is configured to generate a data output on the PUF output based on a memory state in at least one SRAM bit cell among the plurality of SRAM bit cells accessed in a read operation to the PUF memory array. The PUF memory also comprises a PUF stress control circuit. The PUF stress control circuit is configured to receive the data output in response to the read operation to the accessed at least one SRAM bit cell in the PUF memory array. The PUF stress control circuit is configured to determine a logic state skew of the accessed at least one SRAM bit cell based on the data output. The PUF stress control circuit is configured to cause a stress voltage to be applied to the accessed at least one SRAM bit cell based on the determined logic state skew.

### BRIEF DESCRIPTION OF THE FIGURES

FIG. 1 is a schematic diagram of an exemplary static random access memory (SRAM) bit cell that can be used as a physically unclonable function (PUF) cell in a PUF circuit;

FIGS. 2A and 2B are graphs illustrating neutral skew and a logic ‘1’ state skew, respectively, in an SRAM bit cell;

FIG. 3A is an exemplary SRAM bit cell whose cross-coupled inverters are mismatched such that a logic state ‘1’ is stored in its true storage output on power-up, and illustrating a pull-up P-type Field-Effect Transistor (PFET) and a pull-down N-type FET (NFET) in the cross-coupled inverters that can be weakened by applying stress voltage to increase the ‘1’ logic state skew of the SRAM bit cell;

FIG. 3B is an exemplary SRAM bit cell whose cross-coupled inverters are mismatched such that a logic state ‘0’ is stored in its true storage output on power-up, and illustrating a pull-up PFET and a pull-down NFET in the cross-coupled inverters that can be weakened by applying stress voltage to increase the ‘0’ logic state skew of the SRAM bit cell;

FIGS. 4A and 4B illustrate a PFET in an on, negative bias temperature instability (NBTI) stressed state and in an off, unstressed recovery state, respectively;

FIG. 5 is a graph illustrating stress and recovery cycles of the PFET in FIGS. 4A and 4B to illustrate a threshold voltage of the PFET increasing over time due to an NBTI aging effect, thus decreasing switching speed and lowering drive strength of the PFET resulting in a weakened PFET;

FIG. 6A is a schematic diagram of an exemplary PUF memory that includes a PUF memory array comprising a plurality of SRAM bit cells addressable by row and column, supporting access circuitry, and a PUF stress control circuit configured to determine skew of the SRAM bit cells and apply stress to the SRAM bit cells to increase their natural logic state skew for increased PUF output reproducibility;

FIG. 6B illustrates the PUF memory array in the PUF memory in FIG. 6A and shows the natural logic state skew of the SRAM bit cells read after a power-up of the PUF memory, and a pull-up PFET and a pull-down NFET in the cross-coupled inverters in each SRAM bit cell that can be weakened by applying stress voltage to increase the natural logic state skew of the SRAM bit cell;

FIG. 7A illustrates the PUF memory array in the PUF memory in FIG. 6A and with stress voltage being applied to pull-up PFETs in the inverters in the SRAM bit cells identified as being weaker than their counterpart pull-up PFETs in the cross-coupled inverters to increase the natural logic state skew of the SRAM bit cell;

FIG. 7B illustrates the PUF memory array in the PUF memory in FIG. 6A and with stress voltage being applied to pull-down NFETs in the inverters in the SRAM bit cells identified as being weaker than their counterpart pull-down NFETs in the cross-coupled inverters to increase the natural logic state skew of the SRAM bit cell;

FIG. 8 is a flowchart illustrating an exemplary process of the PUF memory in FIGS. 6A and 6B performing a PUF initialization operation in an initialization mode to determine the natural logic state skew of the SRAM bit cells in the PUF memory array and apply stress voltage to the SRAM bit cells to increase their natural logic state skew for increased PUF output reproducibility, and perform PUF read operations in a normal operating mode;

FIG. 9 illustrates a read operation to the SRAM bit cells in the PUF memory array in FIGS. 6A and 6B in a PUF read operation after the SRAM bit cells have been stressed to increase their determined natural logic state skew;

FIG. 10A illustrates an alternative method of applying stress to pull-up PFETs in inverters in the SRAM bit cells in the PUF memory array in FIGS. 6A and 6B identified as being weaker than their counterpart pull-up PFETs in the cross-coupled inverters to increase the natural logic state skew of the SRAM bit cell;

FIG. 10B illustrates an alternative method of applying stress to pull-down PFETs in inverters in the SRAM bit cells in the PUF memory array in FIGS. 6A and 6B identified as being weaker than their counterpart pull-down NFETs in the cross-coupled inverters to increase the natural logic state skew of the SRAM bit cell;

FIG. 11A illustrates an SRAM bit cell in the PUF memory array in the PUF memory in FIG. 6A with a logic ‘0’ stored on its complement storage output;

FIG. 11B is a table illustrating an exemplary likelihood probability analysis of a logic state stored in the SRAM bit cell in FIG. 11A based on different strength comparisons between pull-up PFETs and pull-down NFETs in the cross-coupled inverters in the SRAM bit cell;

FIG. 11C illustrates exemplary Bayseian probability calculations of the natural logic state skew of the SRAM bit cell in FIG. 11A based on the likelihood probability analysis in FIG. 11B and read logic state stored in the SRAM bit cell;

FIG. 12A illustrates formulas for the Bayseian probability calculations in FIG. 11C for a natural logic state skew of ‘0’ in the SRAM bit cell in FIG. 11A;

FIG. 12B is a graph illustrating a Bayseian inference probability curve for a natural logic state skew of ‘0’ based on the Bayseian probability calculations in FIGS. 11B and 12A;

FIG. 13A illustrates the formulas for the Bayseian probability calculations in FIG. 11C for a natural logic state skew of ‘0’ in the SRAM bit cell in FIG. 11A;

FIG. 13B is a graph illustrating a Bayseian inference probability curve for a natural logic state skew of ‘1’ based on the Bayseian probability calculations in FIGS. 11B and 13A;

FIG. 14 is a block diagram of an exemplary processor-based system that includes one or more memory systems that can each include a PUF memory employing a PUF memory array comprising one or more SRAM bit cells and a PUF stress control circuit configured to apply stress to the SRAM bit cell(s) for increased PUF output reproducibility, including but not limited to the PUF memory in FIGS. 6A and 6B; and

FIG. 15 is a block diagram of an exemplary wireless communications device that includes radio frequency (RF) components formed in an integrated circuit (IC), wherein any of the components therein can include a PUF memory employing a PUF memory array comprising one or more SRAM bit cells and a PUF stress control circuit configured to apply stress to the SRAM bit cell(s) for increased PUF output reproducibility, including but not limited to the PUF memory in FIGS. 6A and 6B.

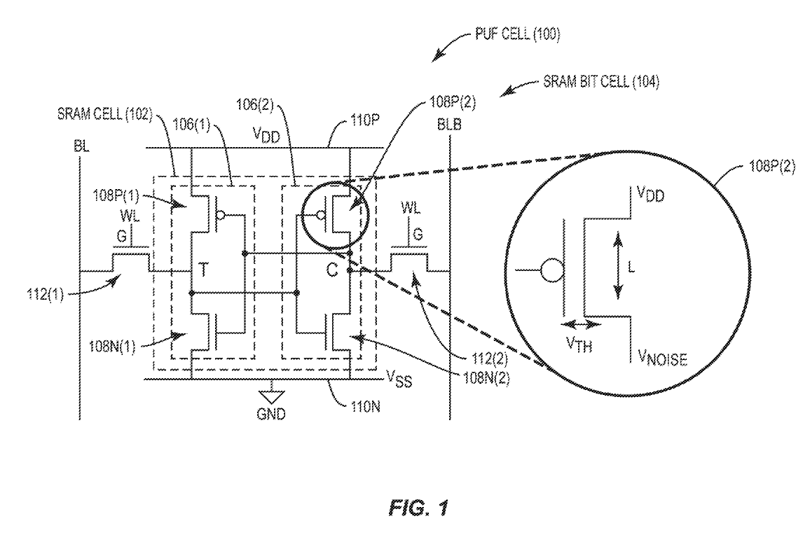

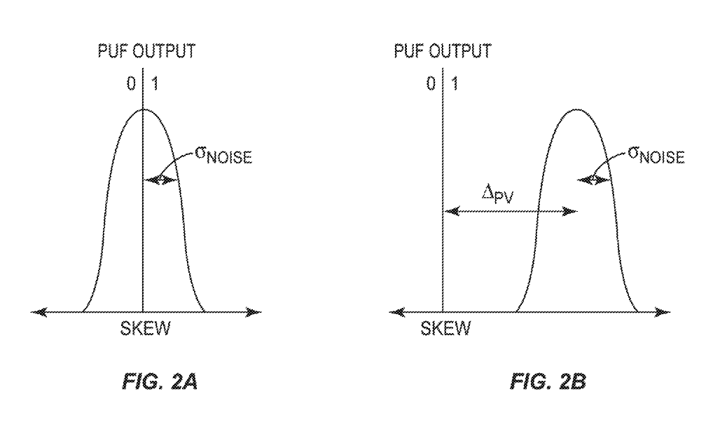

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed herein include physically unclonable function (PUF) memory employing static random access memory (SRAM) bit cells enhanced by stress for increased PUF output reproducibility. An SRAM circuit includes a PUF memory array that is comprised of one or more SRAM bit cells that are addressable to provide a PUF output in the form of a data bit/word output comprised of one or more data bits. In exemplary aspects disclosed herein, for the SRAM bit cells to consistently produce a reproducible PUF output, a stress voltage is applied to the SRAM bit cells to enhance their skew (e.g., mismatch of their cross-coupled inverters), thus outputting their preferred initial state in subsequent PUF read operations regardless of process variation and other external environmental variations, such as temperature. The stress voltage can be applied to the SRAM bit cells during an initialization process for the PUF memory array. The application of stress voltage on the SRAM bit cells takes advantage of the recognition of the aging effect in transistors, where turning transistors on and off over time can increase their threshold voltage, thus weakening the transistors and lowering their drive current. Stress voltage can be applied to the SRAM bit cells to bias their threshold voltage to simulate the aging effect to enhance the mismatch between the transistors in the SRAM bit cells to more fully skew the SRAM bit cells for increased PUF output reproducibility. Thus, a PUF cell employing the stressed SRAM bit cells may be less susceptible to thermal noise which could otherwise cause bit flips if the SRAM bit cells were not sufficiently skewed. Also, in another example, stress on the SRAM bit cells in the PUF memory array may require the PUF memory array to consume less area and less power due to the increased reproducibility of the PUF output to allow a reduction in the complexity of error correction circuitry and a reduction in the number of bit cells provided in the PUF memory array to support error correction.

In further exemplary aspects disclosed herein, a statistical process (e.g., A Bayesian statistical process) can be used in an initialization process performed in the PUF memory array to determine the preferred skewed state of the SRAM bit cells therein. This determined preferred skewed state of the SRAM bit cells can then be used to apply stress voltage to the SRAM bit cells to further enhance the skew (e.g., by weakening certain transistors), thus increasing transistor mismatches (e.g., skew) for increased PUF output reproducibility.

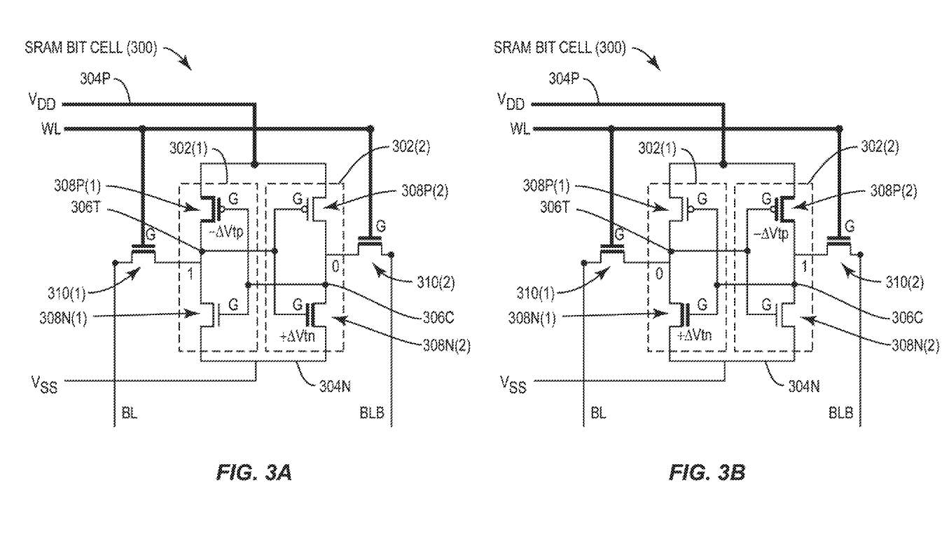

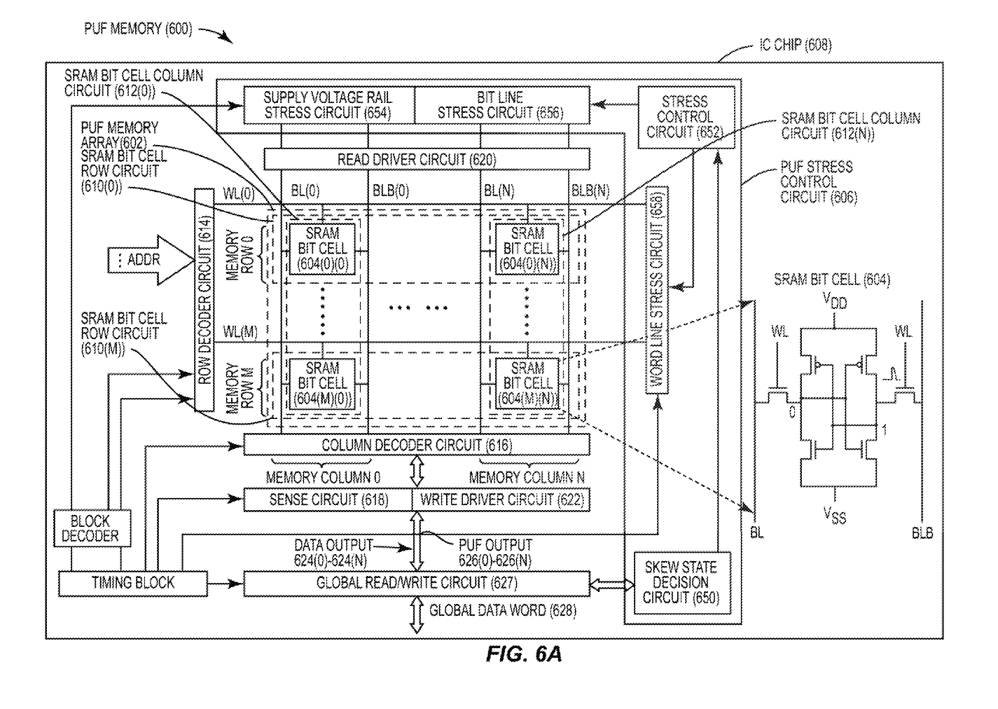

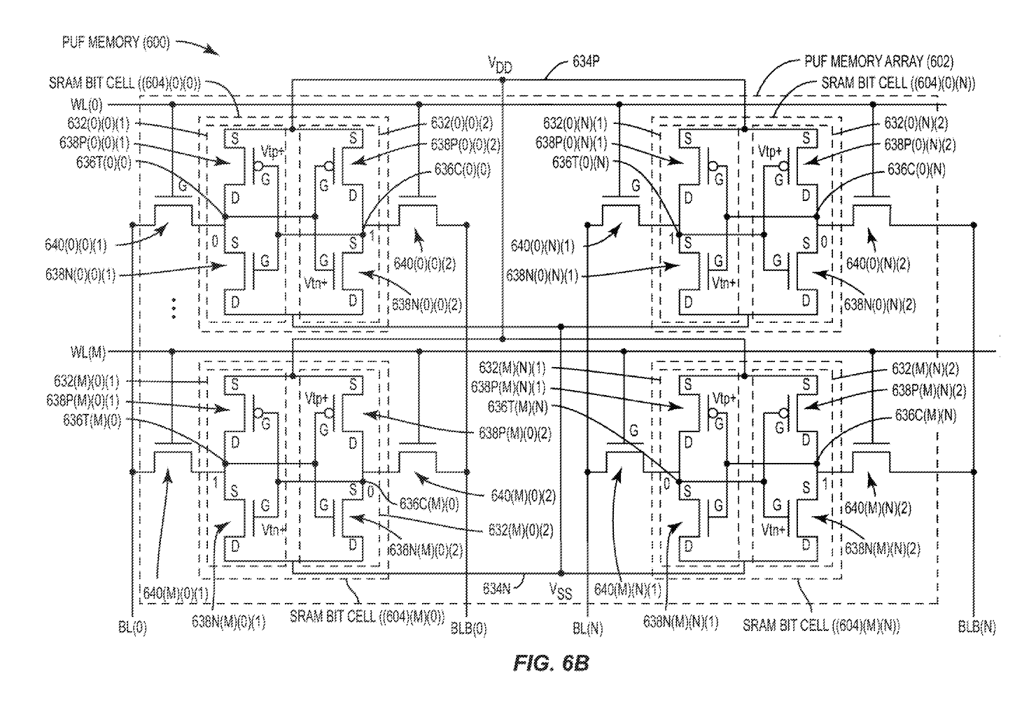

Before discussing an example of PUF memory employing SRAM bit cells enhanced by stress for increased PUF output reproducibility starting at FIG. 6A, an exemplary SRAM bit cell is first discussed starting at FIGS. 3A and 3B. FIGS. 3A-5 discuss how weakening drive strength in transistors in cross-coupled inverters can further enhance the natural skew in an SRAM bit cell for increased PUF output reproducibility.

In this regard, FIGS. 3A and 3B illustrates an exemplary SRAM bit cell 300. In this example, the SRAM bit cell 300 is a six (6) transistor (6-T) static complement memory bit cell. However, the SRAM bit cell 300 does not need to be limited to a 6T SRAM bit cell (e.g., it can be a 7T SRAM or an 8T SRAM bit cell). The SRAM bit cell 300 comprises two (2) cross-coupled inverters 302(1), 302(2) powered by a positive supply voltage V_{DD} on a positive supply voltage rail 304P. The cross-coupled inverters 302(1), 302(2) reinforce each other to retain data in the form of a voltage on a respective true storage output 306T and a complement storage output 306C. Each inverter 302(1), 302(2) is comprised of a respective pull-up P-type Field-Effect Transistor (PFET) 308P(1), 308P(2) coupled in series to a respective pull-down N-type FET (NFET) 308N(1), 308N(2) coupled to a negative supply voltage rail 304N configured to receive a negative supply voltage V_{SS}, which may be a lower voltage than the positive supply voltage V_{DD} or coupled to ground. The NFET access transistors 312(1), 312(2) are coupled to the respective inverters 302(1), 302(2) to provide read and write access to the SRAM bit cell 300. In a read operation, a bit line BL and a complement bit line BLB are pre-charged to half of the positive supply voltage V_{DD}. Then, a word line WL coupled to gates G of the pull-down NFETs 308N(1), 308N(2) is asserted to evaluate the differential voltages on the true storage output 306T and complement storage output 306C to read the SRAM bit cell 300. If a logic high voltage level (i.e., a ‘1’) is stored at the true storage output 306T as shown in FIG. 3A, a logic low voltage level (i.e., ‘0’) is stored at the complement storage output 306C. If a logic low voltage level (i.e., a ‘0’) is stored at the true storage output 306T as shown in FIG. 3B, a logic high voltage level (i.e., ‘1’) is stored at the complement storage output 306C. Assertion of the word line WL will cause the NFET access transistor 310(2) to discharge the pre-charged voltage on the complement bit line BLB to the complement storage output 306C and through the NFET access transistor 310(2) to the negative supply voltage rail 304N.

Thus, the SRAM bit cell 300 in FIGS. 3A and 3B can be used in a PUF memory to generate a random PUF output. Either the true storage output 306T or complement storage output 306C can be used as the random PUF output. Ideally, the inverters 302(1), 302(2) in the SRAM bit cell 300 in FIGS. 3A and 3B will be symmetrically matched so that the SRAM bit cell 300 is not skewed to favor settling to one voltage state over the other to provide a random PUF output when the SRAM bit cell 300 is first read. However, process variations can cause the pull-up PFETs 308P(1), 308P(2) and the pull-down NFETs 308N(1), 308N(2) in the respective inverters 302(1), 302(2) in the SRAM bit cell 300 in FIGS. 3A and 3B to be mismatched, and thus be skewed towards one voltage state. For example, if the SRAM bit cell 300 in FIGS. 3A and 3B is read first before being written, the relative drive strengths between the pull-up PFETs 308P(1), 308P(2) and the relative drive strengths between the pull-down NFETs 308N(1), 308N(2) determine if the SRAM bit cell 300 is skewed to generate a logic ‘0’ or logic ‘1’ on the true storage output 306T and vice versa on the complementary storage output 306C when power is applied to the SRAM bit cell 300. For example, as shown in FIG. 3A, if the pull-up PFET 308P(1) has a higher drive strength (i.e., lower threshold voltage) than the pull-up PFET 308P(2), the pull-up PFET 308P(1) will switch faster than the pull-up PFET 308P(2), thus pulling the true storage output 306T to the positive supply voltage rail 304P, turning off the pull-up PFET 308P(2) and turning on pull-down NFET 308N(2) to store a logic ‘1’ memory state on the true storage output 306T. However, as shown in FIG. 3B, if the pull-up PFET 308P(2) has a higher drive strength (i.e., lower threshold voltage) than the pull-up PFET 308P(1), the pull-up PFET 308P(2) will switch faster than the pull-up PFET 308P(1), thus pulling the complement storage output 306C to the positive supply voltage rail 304P, turning off the pull-up PFET 308P(1) and turning on the pull-down NFET 308N(1) to store a logic ‘0’ memory state on the true storage output 306T.

Thus, the SRAM bit cell 300 in FIG. 3A can be used to provide PUF memory cells by taking advantage of this imbalance (i.e., skew) between the inverters 302(1), 302(2) that will occur through process variation to provide a random, but repeatable output. However, if the mismatch in drive strength (i.e., skew) between the inverters 302(1), 302(2) is not large enough, the SRAM bit cell 300 may not generate a repeatable output between different power up and read operations. A logic state could be written first to the SRAM bit cell 300 to avoid an unrepeatable output in subsequent read operations. However, the output of the SRAM bit cell 300 would then not be random. However, as will be discussed in more detail below, the mismatch in drive strength between the inverters 302(1), 302(2) in the SRAM bit cell 300 is varied so that the skew of the SRAM bit cell 300 is enhanced to provide a random, yet repeatable output.

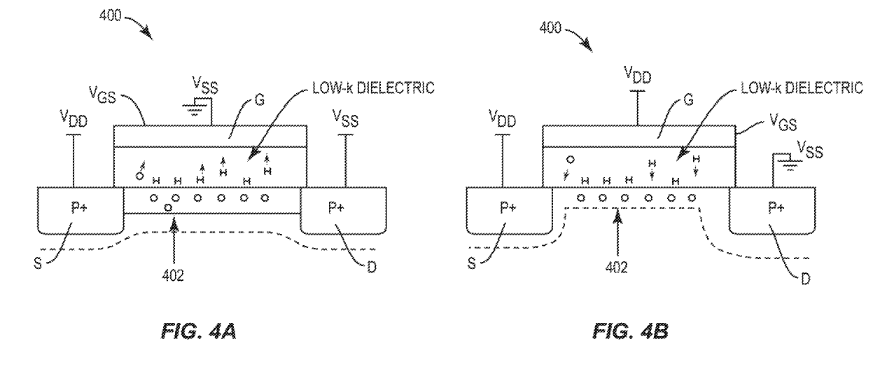

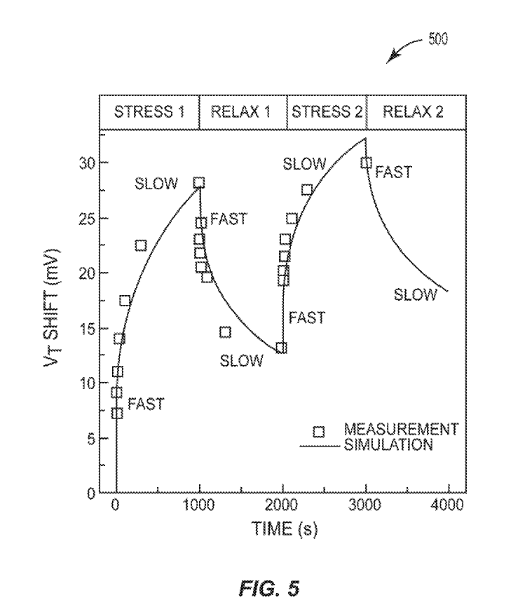

For example, FIGS. 4A and 4B illustrate a PFET 400 in an on, stressed state and in an off, unstressed recovery state, respectively. As shown in FIG. 4A, a gate-to-source voltage V_{GS} at or less than a threshold voltage of the PFET 400 (e.g., the negative supply voltage V_{SS}) is applied to a gate of the PFET 400 to turn on the PFET 400, and creates a hole inversion layer in a channel 402 to allow current to flow between the source or drain S/D and a drain or source D/S. As shown in FIG. 4B, a voltage greater than the threshold voltage of the PFET 400 (e.g., the negative supply voltage V_{SS}) is applied to a gate of the PFET 400 to turn off the PFET 400 and eliminate the hole inversion layer in the channel 402 such that current (other than leakage current) does not flow between the source or drain S/D and the drain or source D/S. However, applying the gate-to-source voltage V_{GS} less than the threshold voltage of the PFET 400 in the on state creates a negative-base temperature instability (NBTI) in the PFET 400. Stress applied to the PFET 400 is a function of the amount of NBTI present. A NBTI in the PFET 400 can also occur as a function of elevated temperatures in the PFET 400. After the PFET 400 is turned off, the PFET 400 enters a relaxed or recovery state. As shown in a graph 500 in FIG. 5, repeated application of stress and recovery to the PFET 400 over a period of time can increase the threshold voltage of the PFET 400, thus decreasing conductance and effective carrier mobility in the channel 402, thus decreasing the drive strength of the PFET 400. Hot carrier injection (HCI) where charge carriers become trapped in the gate dielectric and gate spacer of the PFET 400 in FIGS. 4A and 4B can also change the switching characteristics of the PFET 400 by increasing the threshold voltage of the PFET 400 and thus lowering its drive strength. Thus, if the mismatch in the inverters 302(1), 302(2) of the SRAM bit cell 300 in FIGS. 3A and 3B can be determined, a stress voltage can thereafter be applied in an initialization process to a weaker transistor(s) with a lower drive strength in the SRAM bit cell 300 to further enhance the mismatch or skew between the inverters 302(1), 302(2) to simulate the NBTI and/or HCI effect on the transistors therein. This can have the effect of enhancing the skew between the inverters 302(1), 302(2) so that the output of the SRAM bit cell 300 in response to a read operation is highly repeatable.

The application of stress voltage on an SRAM bit cell takes advantage of the recognition of the aging effect in transistors, where turning transistors on and off over time can increase their threshold voltage, thus weakening the transistors and lowering their drive current. Thus, a PUF cell employing stressed SRAM bit cells may be less susceptible to thermal noise which could otherwise cause bit flips if the SRAM bit cells were not sufficiently skewed. Also, in another example, stress on the SRAM bit cells in the PUF memory array may require the PUF memory array to consume less area and consume less power due to the increase in reproducibility of the PUF output, which can allow a reduction in the complexity of error correction circuitry and a reduction in the number of SRAM bit cells provided in the PUF memory array to support error correction.

In this regard, FIG. 6A is a block diagram of an exemplary PUF memory 600 that includes a PUF memory array 602 comprised of a plurality of SRAM bit cells 604(0)(0)-604(M)(N) to support PUF operations. FIG. 6B illustrates the SRAM bit cells 604(0)(0)-604(M)(N) in the PUF memory array 602 in more detail. As will be discussed in more detail below, the SRAM bit cells 604(0)(0)-604(M)(N) are addressable by row and column. The PUF memory 600 also includes supporting access circuitry used to perform read and write operations to the SRAM bit cells 604(0)(0)-604(M)(N). The PUF memory 600 also includes a PUF stress control circuit 606 configured to determine the skew of the SRAM bit cells 604(0)(0)-604(M)(N) in an initialization process and then apply stress voltage to selected SRAM bit cells 604(0)(0)-604(M)(N) to increase their natural logic state skew for increased PUF output reproducibility.

With reference to FIG. 6A, the PUF memory 600 may be provided on a separate IC chip 608 from a processor or integrated into the same IC chip as a processor. In this example, the PUF memory array 602 includes a plurality of SRAM bit cells 604(0)(0)-604(M)(N) organized into ‘M+1’ memory rows 0-M and ‘N+1’ memory columns 0-N. Each SRAM bit cell 604(0)(0)-604(M)(N) is configured to generate an output to represent a stored memory state. For example, in this example, each SRAM bit cell 604(0)(0)-604(M)(N) is a 6-T transistor circuit like the SRAM bit cell 300 in FIGS. 3A and 3B. The PUF memory array 602 includes a plurality of SRAM bit cell row circuits 610(0)-610(M) each provided in a respective memory row 0-M. Each SRAM bit cell row circuit 610(0)-610(M) includes a plurality of SRAM bit cells 604( )(0)-408( )(N) each provided in a respective memory column 0-N for generating a PUF output. The SRAM bit cells 604(0)(0)-604(M)(N) are also organized in their respective memory columns 0-N to form respective SRAM bit cell column circuits 612(0)-612(N). Each SRAM bit cell column circuit 612(0)-612(N) includes a plurality of SRAM bit cells 604(0)( )-408(M)( ) each provided in a respective memory row 0-M.

With continuing reference to FIG. 6A, the PUF memory 600 includes a row decoder circuit 614, a column decoder circuit 616, and a sense circuit 618. The row decoder circuit 614 is coupled to the PUF memory array 602 via word lines WL(0)-WL(M). Word lines WL(0)-WL(M) are coupled to the SRAM bit cells 604(0)(0)-604(M)(N) in the respective SRAM bit cell row circuits 610(0)-610(M). The row decoder circuit 614 is configured to assert one or more word lines WL(0)-WL(M) in response to a particular memory address ADDR received by the PUF memory 600 to initiate a PUF access (e.g., read) operation to the PUF memory array 602. The column decoder circuit 616 is coupled to the PUF memory array 602 via bit lines BL(0)-BL(N) and complement bit lines BLB(0)-BLB(N). A read driver circuit 620 is provided and coupled to the SRAM bit cell column circuits 612(0)-612(N) to pre-charge the bit lines BL(0)-BL(N) and complement bit lines BLB(0)-BLB(N) with voltages to setup a read operation to the SRAM bit cells 604(0)(0)-604(M)(N) in a selected SRAM bit cell row circuit 610(0)-610(N). A write driver circuit 622 is coupled to the SRAM bit cell column circuits 612(0)-612(N) to generate a write voltage on the bit lines BL(0)-BL(N) and complement bit lines BLB(0)-BLB(N) to write data from an SRAM bit cell 604(0)(0)-604(M)(N) in a selected SRAM bit cell row circuit 610(0)-610(M).

With continuing reference to FIG. 6A, the sense circuit 618 may be coupled to the PUF memory array 602 via the bit lines BL(0)-BL(N) and the complement bit lines BLB(0)-BLB(N). The sense circuit 618 may be configured to generate a data output 624(0)-624(N) on a PUF output 626(0)-626(N) of ‘N+1’ bits. A logic state of the data output 624(0)-624(N) on the PUF output 626(0)-626(N) is based on the sensed voltages on the bit lines BL(0)-BL(N) and the complement bit lines BLB(0)-BLB(N) in response to a PUF read operation. The voltages of the bit lines BL(0)-BL(N) and the complement bit lines BLB(0)-BLB(N) during a read phase are indicative of the memory state of the SRAM bit cells 604(0)(0)-604(M)(N) coupled to the bit lines BL(0)-BL(N) and the complement bit lines BLB(0)-BLB(N). For example, in response to a PUF read operation, the read driver circuit 620 asserts and de-asserts control signals to cause the SRAM bit cells 604(0)(0)-604(M)(N) in the selected SRAM bit cell row circuit 610(0)-610(M) according to the activated word line WL(0)-WL(M) generated by the row decoder circuit 614 to generate the data output 624(0)-624(N) on the PUF output 626(0)-626(N). To illustrate, the sense circuit 618 may output the data output 624(0)-624(N) (e.g., a “response”) in response to a particular memory address (e.g., a “challenge”). In this manner, the PUF memory array 602 may output different data outputs 624(0)-624(N) (e.g., different “responses”) based on different addresses (e.g., different “challenges”). The data outputs 624(0)-624(N) can be provided on a global read/write circuit 627 to provide a global data word 628 in a processor.

A data output 624(0)-624(N) in the form of a product identifier (or an identification or authorization process using PUF challenges and responses), a cryptographic key, or both may include (or be generated based on) the PUF output 626(0)-626(N). Because the data output 624(0)-624(N) is based on process-dependent variations in the transistors in the SRAM bit cells 604(0)(0)-604(M)(N) in the PUF memory array 602, the device identifier or the cryptographic key may be difficult or impossible to generate at another device.

FIG. 6B illustrates the SRAM bit cells 604(0)(0)-604(M)(N) in the PUF memory array 602 in the PUF memory 600 in FIG. 6A in more detail to discuss logic state skew of the SRAM bit cells 604(0)(0)-604(M)(N). Like the SRAM bit cell 300 in FIGS. 3A and 3B, the SRAM bit cells 604(0)(0)-604(M)(N) are 6-T static complement memory bit cells in this example. Each SRAM bit cell 604(0)(0)-604(M)(N) comprises two (2) cross-coupled inverters 632(0)(0)(1), 632(0)(0)(2)-632(M)(N)(1), 632(M)(N)(2) powered by a positive supply voltage V_{DD} on a positive supply voltage rail 634P. The cross-coupled inverters 632(0)(0)(1), 632(0)(0)(2)-632(M)(N)(1), 632(M)(N)(2) reinforce each other to retain data in the form of a voltage on a respective true storage output 636T(0)(0)-636T(M)(N) and a complement storage output 636C(0)(0)-636C(M)(N). Using SRAM bit cells 604(0)(0), 604(0)(N) as an example, the inverters 632(0)(0)(1), 632(0)(0)(2), 632(0)(N)(1), 632(0)(N)(2) are each comprised of a respective pull-up PFET 638P(0)(0)(1), 638P(0)(0)(2), 638P(0)(N)(1), 638P(0)(N)(2), coupled to a respective pull-down NFET 638N(0)(0)(1), 638N(0)(0)(2), 638N(0)(N)(1), 638N(0)(N)(2). The pull-up PFETs 638P(0)(0)(1), 638P(0)(0)(2), 638P(0)(N)(1), 638P(0)(N)(2) are coupled to the positive supply voltage rail 634P configured to receive the positive supply voltage V_{DD}. The pull-down NFETs 638N(0)(0)(1), 638N(0)(0)(2), 638N(0)(N)(1), 638N(0)(N)(2) are coupled to a negative supply voltage rail 634N configured to receive a negative supply voltage V_{SS}. NFET access transistors 640(0)(0)(1), 640(0)(0)(2), 640(0)(N)(1), 640(0)(N)(2) are coupled to the respective inverters 632(0)(0)(1), 632(0)(0)(2), 632(0)(N)(1), 632(0)(N)(2) to provide read and write access to the SRAM bit cells 604(0)(0), 604(0)(N).

In a read operation to the SRAM bit cells 604(0)(0)-604(0)(N), the bit lines BL(0)-BL(N) and complement bit lines BLB(0)-BLB(N) are pre-charged to the positive supply voltage V_{DD}. Then, a word line WL(0) coupled to gates G of the NFET access transistors 640(0)(0)(1), 640(0)(0)(2)-640(0)(N)(1), 640(0)(N)(2) is asserted to evaluate the differential voltages on the true storage output 636T(0)(0)-636T(0)(N) and complement storage output 636C(0)(0)-636C(0)(N) to read the SRAM bit cells 604(0)(0)-604(0)(N). If a logic high voltage level (i.e., a ‘1’) is stored at the true storage output 636T(0)(0) as shown for the SRAM bit cell 604(0)(0) in FIG. 6B, a logic low voltage level (i.e., ‘0’) is stored at the complement storage output 636C(0)(0). If a logic low voltage level (i.e., a ‘0’) is stored at the true storage output 636T(0)(N) as shown for the SRAM bit cell 604(0)(N) in FIG. 6B, a logic high voltage level (i.e., ‘1’) is stored at the complement storage output 636C(0)(N). Assertion of the word line WL(0) will cause the NFET access transistors 640(0)(0)(1), 640(0)(0)(2)-640(0)(N)(1), 640(0)(N)(2) to discharge the pre-charged voltage on the complement bit lines BLB(0)-BLB(N) to the respective complement storage outputs 636C(0)(0)-636C(0)(N) and through the respective NFET access transistors 640(0)(0)(1), 640(0)(0)(2)-640(0)(N)(1), 640(0)(N)(2) to the negative supply voltage rail 634N.

Like discussed for the SRAM bit cell 300 in FIGS. 3A and 3B, ideally, the inverters 632(0)(0)(1), 632(0)(0)(2), 632(0)(N)(1), 632(0)(N)(2) in the SRAM bit cells 604(0)(0)-604(0)(N) in FIG. 6B will be symmetrically matched so that each SRAM bit cell 604(0)(0)-604(0)(N) is not skewed to favor settling to one voltage state over the other to provide a random PUF output when the SRAM bit cells 604(0)(0)-604(0)(N) are first read. However, process variations can cause the pull-up PFETs 638P(0)(0)(1), 638P(0)(0)(2), 638P(0)(N)(1), 638P(0)(N)(2) and the pull-down NFETs 638N(0)(0)(1), 638N(0)(0)(2), 638N(0)(N)(1), 638N(0)(N)(2) in the respective inverters 632(0)(0)(1), 632(0)(0)(2), 632(0)(N)(1), 632(0)(N)(2) in the SRAM bit cell 300 in FIGS. 3A and 3B to be mismatched, and thus be skewed towards one voltage state after SRAM power up. Thus, as discussed in more detail below, after a read operation to a selected memory row 0-M of SRAM bit cells 604(0)(0)-604(M)(N) is performed in an initialization process, a pull-up PFET 638P(0)(0)(1), 638P(0)(0)(2)-638P(M)(N)(1), 638P(M)(N)(2) and a pull-down NFET 638N(0)(0)(1), 638N(0)(0)(2)-638N(M)(N)(1), 638N(M)(N)(2) can be weakened by applying a stress voltage to the increased the natural logic state skew of the SRAM bit cells 604(0)(0)-604(M)(N).

In this regard, turning back to FIG. 6A, the PUF memory 600 in this example includes the PUF stress control circuit 606. In this example, the PUF stress control circuit 606 includes a skew state decision circuit 650 coupled to the PUF output 626(0)-626(N) of the PUF memory array 602. In an initialization operation after power up of the PUF memory array 602, the skew state decision circuit 650 is configured to receive the data output 624(0)-624(N) from the PUF output 626(0)-626(N) in response to a PUF statistical read operation to an SRAM bit cell 604(0)(0)-604(M)(N) in a selected SRAM bit cell row circuit 610(0)-610(M) for multiple power up/power down cycles. The skew state decision circuit 650 is configured to determine the logic state skew of the SRAM bit cells 604(0)(0)-604(M)(N) in a selected SRAM bit cell row circuit 610(0)-610(M) based on the statistical data output 624(0)-624(N). The PUF stress control circuit 606 also includes a stress control circuit 652 coupled to the PUF memory array 602 and the skew state decision circuit 650. Also, after the initialization operation, the stress control circuit 652 is configured to write back the reverse determined logic state skew to a selected SRAM bit cell 604(0)(0)-604(M)(N) in the selected SRAM bit cell row circuit 610(0)-610(M) of the PUF memory array 602, and to cause a stress voltage to be applied to the SRAM bit cells 604(0)(0)-604(M)(N) in a selected SRAM bit cell row circuit 610(0)-610(M) based on their determined logic state skew in the data output 624(0)-624(N). In this manner, the SRAM bit cells 604(0)(0)-604(M)(N) in a selected SRAM bit cell row circuit 610(0)-610(M) based on the data output 624(0)-624(N) can be stressed to further enhance their logic state skew. Thus, when subsequent PUF read operations are performed to the PUF memory array 602 in normal operations, the skew in the accessed SRAM bit cells 604(0)(0)-604(M)(N) will be enhanced such that the data output 624(0)-624(N) representing their stored logic states can be repeatably reproduced. A stress voltage can be applied to a subset or all of the SRAM bit cells 604(0)(0)-604(M)(N) in the PUF memory array 602 as desired and controlled by the PUF stress control circuit 606.

With continuing reference to FIG. 6A, in this example, the PUF stress control circuit 606 includes other exemplary circuits that are employed to apply stress voltage to the SRAM bit cells 604(0)(0)-604(M)(N). The stress control circuit 652 is configured to interface with these other circuits to write back the reverse determined logic state skew to the selected SRAM bit cells 604(0)(0)-604(M)(N) in the selected SRAM bit cell row circuit 610(0)-610(M) of the PUF memory array 602, and apply stress voltage to the SRAM bit cells 604(0)(0)-604(M)(N) in a manner that is consistent with the logic state skew of the SRAM bit cells 604(0)(0)-604(M)(N) determined by the skew state decision circuit 650 in the initialization operation discussed above. In this regard, in this example, the PUF stress control circuit 606 includes a supply voltage rail stress circuit 654. The supply voltage rail stress circuit 654 is coupled to the stress control circuit 652 and the positive supply voltage rail 634P. The stress control circuit 652 is configured to cause the supply voltage rail stress circuit 654 to write back reverse determined logic state skew to the selected SRAM bit cells 604(0)(0)-604(M)(N) in the selected SRAM bit cell row circuit 610(0)-610(M) of the PUF memory array 602, and apply a stress voltage to the SRAM bit cells 604(0)(0)-604(M)(N) in a selected SRAM bit cell row circuit 610(0)-610(M) based on the determined logic state skew by the skew state decision circuit 650. For example, as discussed in more detail below, the supply voltage rail stress circuit 654 may be configured to apply a positively boosted voltage above the positive supply voltage V_{DD} to the positive supply voltage rail 634P to stress SRAM bit cells 604(0)(0)-604(M)(N) in the selected SRAM bit cell row circuit 610(0)-610(M). Also in this example, the PUF stress control circuit 606 includes a bit line stress circuit 656. The bit line stress circuit 656 is coupled to the bit lines BL(0)-BL(N) and the complement bit lines BLB(0)-BLB(N) and the stress control circuit 652. The stress control circuit 652 is configured to cause the bit line stress circuit 656 to apply a stress voltage to the bit lines BL(0)-BL(N) and the complement bit lines BLB(0)-BLB(N) to stress SRAM bit cells 604(0)(0)-604(M)(N) in the selected SRAM bit cell row circuit 610(0)-610(M). Also in this example, the PUF stress control circuit 606 also includes a word line stress circuit 658. The word line stress circuit 658 is coupled to the word lines WL(0)-WL(M) and the stress control circuit 652. The stress control circuit 652 is configured to cause the word line stress circuit 658 to select the word line WL(0)-WL(M) of the SRAM bit cells 604(0)(0)-604(M)(N) in the selected SRAM bit cell row circuit 610(0)-610(M) to be stressed. The stress control circuit 652 causes the word line stress circuit 658, the bit line stress circuit 656, and the supply voltage rail stress circuit 654 to act in concert with each other to select the SRAM bit cells 604(0)(0)-604(M)(N) in the selected SRAM bit cell row circuit 610(0)-610(M) identified to be stressed to apply voltages to the bit lines BL(0)-BL(N) and the complement bit lines BLB(0)-BLB(N) and the positive supply voltage rail 634P to stress SRAM bit cells 604(0)(0)-604(M)(N) in the selected SRAM bit cell row circuit 610(0)-610(M) based on the reverse determined logic state skew of the selected SRAM bit cells 604(0)(0)-604(M)(N) determined by the skew state decision circuit 650 in the initialization operation discussed above.

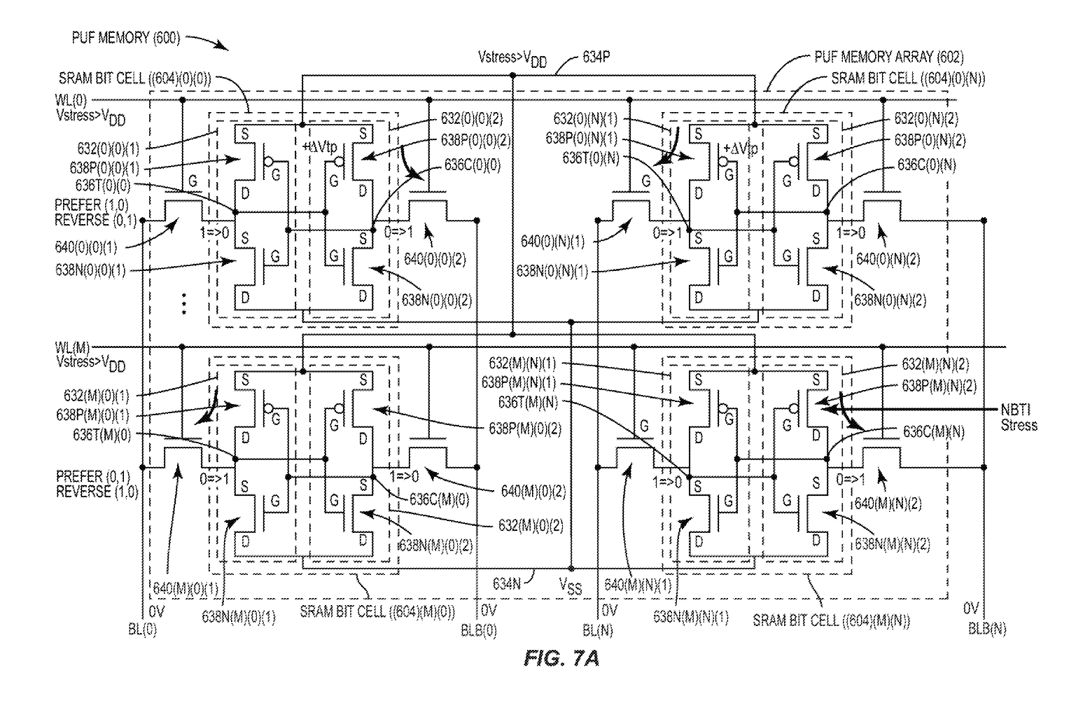

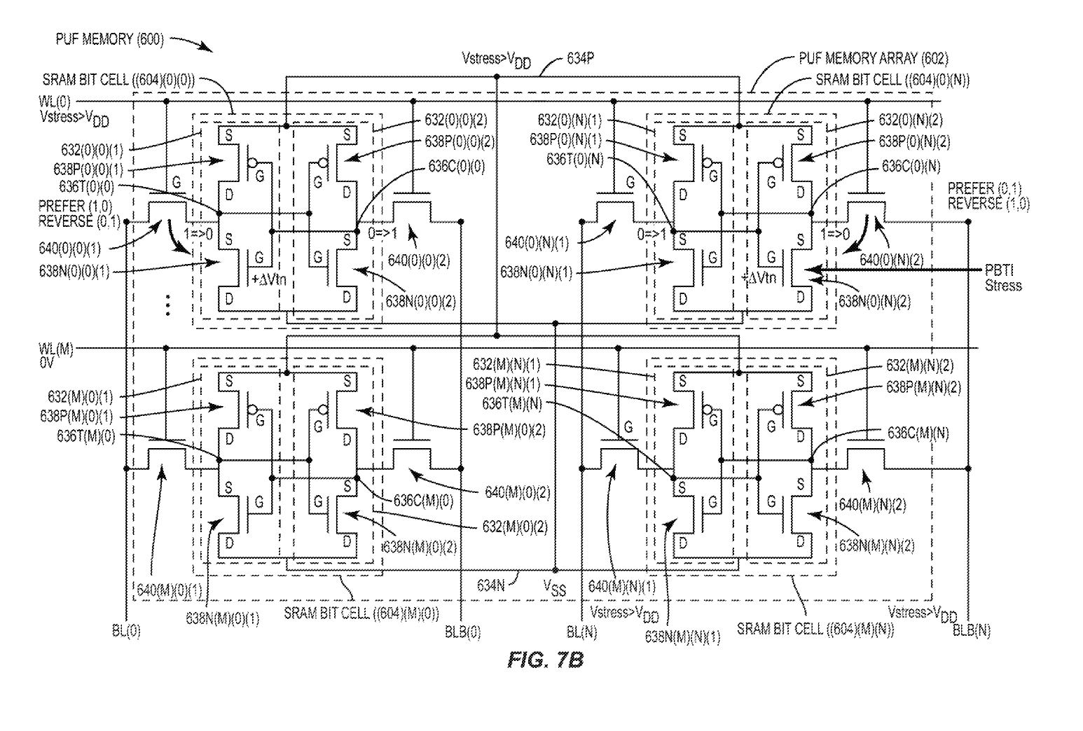

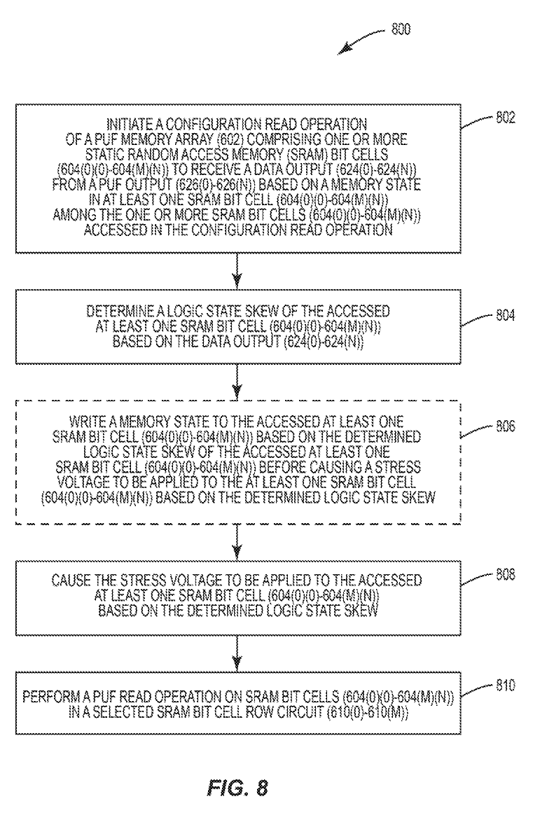

FIG. 7A illustrates an example of stress voltage being applied to pull-up 638P(0)(0)(1), 638P(0)(0)(2)-638P(M)(N)(1), 638P(M)(N)(2) in the inverters 632(0)(0)(1), 632(0)(0)(2), 632(0)(N)(1), 632(0)(N)(2) in the SRAM bit cells 604(0)(0)-604(M)(N) in the PUF memory array 602 in FIG. 6A identified as being weaker than their counterpart pull-up PFETs 638P(0)(0)(1), 638P(0)(0)(2)-638P(M)(N)(1), 638P(M)(N)(2) to increase natural logic state skew of the SRAM bit cells 604(0)(0)-604(M)(N). Note that this example can also be applied to any other SRAM bit cells 604(0)(0)-604(M)(N) in the PUF memory array 602.

As shown in FIG. 7A, the natural logic state skew of the SRAM bit cell 604(0)(0) is a logic ‘1’ memory state as stored in its true storage output 636T(0)(0). As discussed above, this can be determined by the skew state decision circuit 650 in response to a read operation that includes a read operation to the SRAM bit cell 604(0)(0). This means that the pull-up PFET 638P(0)(0)(1) is stronger than pull-up PFET 638P(0)(0)(2) in the respective inverters 632(0)(0)(1), 632(0)(0)(2). This is because the pull-up PFET 638P(0)(0)(1) is activated faster to pull the true storage output 636T(0)(0) to the positive supply voltage rail 634P representing a logic state ‘1’, and turn off the pull-down NFET 638N(0)(0)(2) to turn off the pull-up PFET 638P(0)(0)(2) and turn on the pull-down NFET 638N(0)(0)(2) to pull the complement storage output 636C(0)(0) to the negative supply voltage rail 634N representing a logic state ‘0’. Thus, to further enhance the logic state skew of the SRAM bit cell 604(0)(0), in this example, the stress control circuit 652 writes a reverse memory state of a logic ‘0’ to the true storage output 636T(0)(0) and a logic ‘1’ to the complement storage output 636C(0)(0) as shown in FIG. 7A. This is so that the pull-up PFET 638P(0)(0)(1) is turned off and the pull-up PFET 638P(0)(0)(2) to be weakened by stress voltage is turned on. The stress control circuit 652 causes the supply voltage rail stress circuit 654 to apply a stress voltage greater than the positive supply voltage V_{DD} to the positive supply voltage rail 634P. The stress control circuit 652 also causes the word line stress circuit 658 to apply a stress voltage greater than the positive supply voltage V_{DD} to the word line WL(0), which also activates the NFET access transistors 640(0)(0)(1), 640(0)(0)(2). The stress control circuit 652 also causes the bit line stress circuit 656 to apply a lower voltage (e.g., V_{SS} or 0V) to the complement bit line BLB(0) so that there is a positive voltage drop from the positive supply voltage rail 634P through the pull-up PFET 638P(0)(0)(2) and the NFET access transistor 640(0)(0)(2) to the complement bit line BLB(0) to cause current to flow through the pull-up PFET 638P(0)(0)(2). This places the pull-up PFET 638P(0)(0)(2) in an on state simulating NBTI and/or HCI stress to weaken the pull-up PFET 638P(0)(0)(2) further with respect to the pull-up PFET 638P(0)(0)(1) to enhance the natural skew logic state of the SRAM bit cell 604(0)(0) to a logic ‘1’ on its true storage output 636T(0)(0).

With continuing reference to FIG. 7A, in contrast to the SRAM bit cell 604(0)(0), the natural logic state skew of the SRAM bit cell 604(0)(N) was determined to be a logic ‘0’ memory state stored in its true storage output 636T(0)(N). As discussed above, this can be determined by the skew state decision circuit 650 in response to a statistic read operation that includes a multiple read operation to the SRAM bit cell 604(0)(N) for multiple power up and power down cycles. This means that the pull-up PFET 638P(0)(N)(2) is stronger than the pull-up PFET 638P(0)(N)(1) in the respective inverters 632(0)(N)(1), 632(0)(N)(2). This is because the pull-up PFET 638P(0)(N)(2) is activated faster to pull the true storage output 636T(0)(N) to the positive supply voltage rail 634P representing a logic state ‘1’ and turn off the pull-down NFET 638N(0)(N)(1) to turn off the pull-up PFET 638P(0)(N)(1) and turn on the pull-down NFET 638N(0)(N)(1) to pull the complement storage output 636C(0)(N) to the negative supply voltage rail 634N representing a logic state ‘0’. Thus, to further enhance the logic state skew of the SRAM bit cell 604(0)(N), in this example, the stress control circuit 652 writes a reverse memory state of a logic ‘1’ to the true storage output 636T(0)(N) and a logic ‘0’ to the complement storage output 636C(0)(N) as shown in FIG. 7A. This is so that the pull-up PFET 638P(0)(N)(2) is turned off and the pull-up PFET 638P(0)(N)(1) to be weakened by stress voltage is turned on. The stress control circuit 652 causes the supply voltage rail stress circuit 654 to apply a stress voltage greater than the positive supply voltage V_{DD} to the positive supply voltage rail 634P. The stress control circuit 652 also causes the word line stress circuit 658 to apply a stress voltage greater than the positive supply voltage V_{DD} to the word line WL(0), which also activates the NFET access transistors 640(0)(N)(1), 640(0)(N)(2). The stress control circuit 652 also causes the bit line stress circuit 656 to apply a lower voltage (e.g., V_{SS} or 0V) to the bit line BL(N) so that there is a positive voltage drop from the positive supply voltage rail 634P through the pull-up PFET 638P(0)(N)(1) and the NFET access transistor 640(0)(N)(1) to the bit line BL(N) to cause current to flow through the pull-up PFET 638P(0)(N)(1). This places the pull-up PFET 638P(0)(N)(1) in an on state simulating NBTI and/or HCI stress to weaken the pull-up PFET 638P(0)(N)(1) further with respect to the pull-up PFET 638P(0)(N)(2) to enhance the natural skew logic state of the SRAM bit cell 604(0)(0) to a logic ‘0’ on its true storage output 636T(0)(N).

When the pull-up PFET 638P(0)(0)(2) in inverter 632(0)(0)(2) in SRAM bit cell 604(0)(0) is weakened by stress voltage as shown in FIG. 7A, the stress control circuit 652 can also optionally cause the pull-down NFET 638N(0)(0)(1) in the other inverter 632(0)(0)(1) to also be stressed and weakened. This is to further enhance the natural skew logic state of the SRAM bit cell 604(0)(0) to a logic ‘1’ state on its true storage output 636T(0)(0), because weakening the pull-down NFET 638N(0)(0)(1) means that the pull-down NFET 638N(0)(0)(1) is less likely to switch on fast enough to pull the true storage output 636T(0)(0) to the negative supply voltage rail 634N before the pull-up PFET 638P(0)(0)(1) pulls the true storage output 636T(0)(N) to the positive supply voltage rail 634P, thus flipping the natural skew logic state of the SRAM bit cell 604(0)(0) to a logic ‘0’ state in an undesired manner.

Similarly, such as shown in FIG. 7A, when pull-up PFET 638P(0)(N)(1) in inverter 632(0)(N)(1) in SRAM bit cell 604(0)(N) is weakened by stress voltage, the stress control circuit 652 can also cause the pull-down NFET 638N(0)(N)(2) in the other inverter 632(0)(N)(2) to also be stressed and weakened. This is to also further enhance the natural skew logic state of the SRAM bit cell 604(0)(N) to a logic ‘0’ state on its true storage output 636T(0)(N), because weakening pull-down NFET 638N(0)(N)(2) means that the pull-down NFET 638N(0)(N)(2) is less likely to switch on fast enough to pull the true storage output 636T(0)(N) to the negative supply voltage rail 634N before the pull-up PFET 638P(0)(N)(2) pulls the true storage output 636T(0)(N) to the positive supply voltage rail 634P, which could flip the natural skew logic state of the SRAM bit cell 604(0)(N) to a logic ‘0’ state in an undesired manner. This is shown in FIG. 7B, which is now discussed.

As shown in FIG. 7B, as discussed above, the natural logic state skew of the SRAM bit cell 604(0)(0) is a logic ‘1’ memory state as stored in its true storage output 636T(0)(0). To further enhance the logic state skew of the SRAM bit cell 604(0)(0) in this example, the stress control circuit 652 writes a reverse memory state of a logic ‘0’ to the true storage output 636T(0)(0) and a logic ‘1’ to the complement storage output 636C(0)(0) as previously discussed. This is so that the pull-up PFET 638P(0)(0)(1) is turned off and the pull-up PFET 638P(0)(0)(2) to be weakened by stress voltage is turned on. This also turns on the pull-down NFET 638N(0)(0)(1) to be weakened. Again, the stress control circuit 652 causes the supply voltage rail stress circuit 654 to apply a stress voltage greater than the positive supply voltage V_{DD} to the positive supply voltage rail 634P. The stress control circuit 652 also causes the word line stress circuit 658 to apply a stress voltage greater than the positive supply voltage V_{DD} to the word line WL(0), which also activates the NFET access transistors 640(0)(0)(1), 640(0)(0)(2). The stress control circuit 652 also causes the bit line stress circuit 656 to apply stress voltage greater than the positive supply voltage V_{DD} to the bit line BL(0) and the complement bit line BLB(0). This is so that there is a positive voltage drop from the bit line BL(0) through NFET access transistor 640(0)(0)(1) and the pull-down NFET 638N(0)(0)(1) to the negative supply voltage rail 634N to cause current to flow from the bit line BL(0) to the negative supply voltage rail 634N. This places the pull-down NFET 638N(0)(0)(1) in an on state simulating PBTI and/or HCI stress to weaken the pull-down NFET 638N(0)(0)(1) further to enhance the natural skew logic state of the SRAM bit cell 604(0)(0) to a logic ‘1’ on its true storage output 636T(0)(0).

With continuing reference to FIG. 7B, in contrast to the SRAM bit cell 604(0)(0), the natural logic state skew of the SRAM bit cell 604(0)(N) was determined to be a logic ‘0’ memory state stored in its true storage output 636T(0)(N) as previously discussed. Thus, to further enhance the logic state skew of the SRAM bit cell 604(0)(N), in this example, the stress control circuit 652 writes a reverse memory state of a logic ‘1’ to the true storage output 636T(0)(N) and a logic ‘0’ to the complement storage output 636C(0)(N) as previously discussed. The stress control circuit 652 can also cause the word line stress circuit 658 to apply a stress voltage greater than the positive supply voltage V_{DD} to the word line WL(0), which also activates the NFET access transistors 640(0)(N)(1), 640(0)(N)(2). The stress control circuit 652 also causes the bit line stress circuit 656 to apply stress voltage greater than the positive supply voltage V_{DD} to the bit line BL(N) and the complement bit line BLB(N). This is so that there is a positive voltage drop from the complement bit line BLB(N) through NFET access transistor 640(0)(N)(2) and the pull-down NFET 638N(0)(N)(2) to the negative supply voltage rail 634N to cause current to flow from the complement bit line BLB(N) to the negative supply voltage rail 634N. This places the pull-down NFET 638N(0)(N)(2) in an on state simulating PBTI and/or HCI stress to weaken the pull-down NFET 638N(0)(N)(2) further to enhance the natural skew logic state of the SRAM bit cell 604(0)(N) to a logic ‘1’ on its true storage output 636T(0)(N).

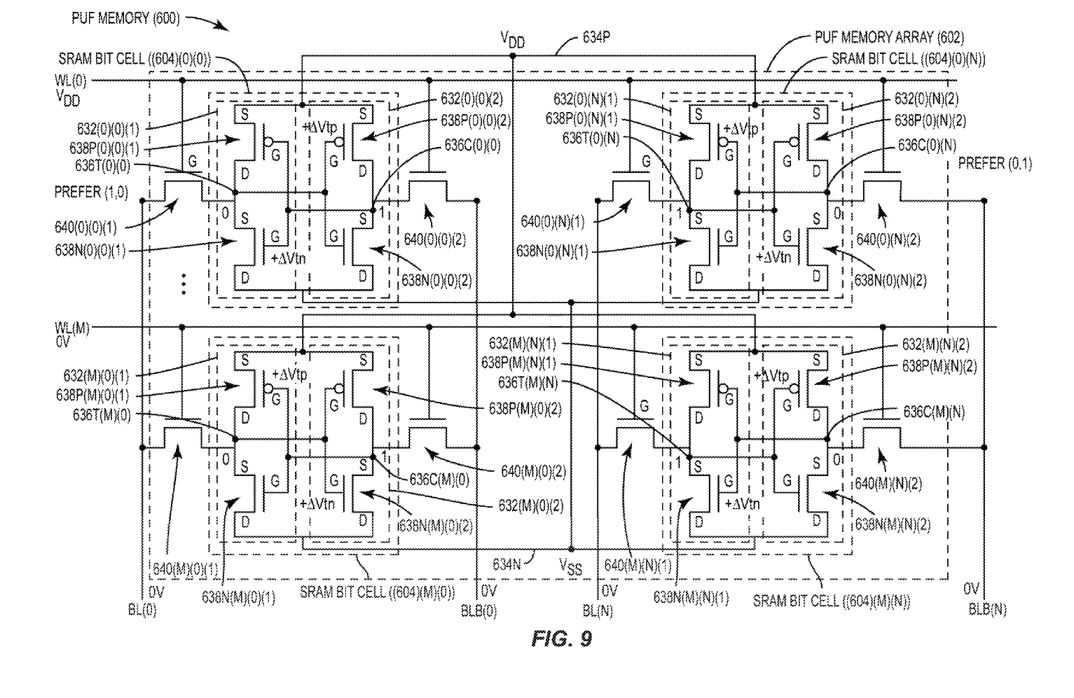

FIG. 8 is a flowchart illustrating an exemplary process 800 of the PUF stress control circuit 606 in the PUF memory 600 in FIG. 6A performing a PUF initialization operation in an initialization mode to determine the natural logic state skew of the selected SRAM bit cells 604(0)(0)-604(M)(N) in the PUF memory array 602 and applying stress voltage to the selected SRAM bit cells 604(0)(0)-604(M)(N) to increase their natural logic state skew for increased PUF output reproducibility, and performing PUF read operations in a normal operating mode. In this regard, the process 800 includes the PUF stress control circuit 606 initiating a configuration read operation of a PUF memory array 602 comprising one or more SRAM bit cells 604(0)(0)-604(M)(N) to receive a data output 624(0)-624(N) from a PUF output 626(0)-626(N) based on a memory state in at least one SRAM bit cell 604(0)(0)-604(M)(N) among the one or more SRAM bit cells 604(0)(0)-604(M)(N) accessed in the configuration read operation (block 802). This is so that the natural logic state skew of the selected SRAM bit cells 604(0)(0)-604(M)(N) can be determined by the skew state decision circuit 650 for example. Note that multiple power-up and power-down cycles may be performed to the PUF memory 600 and a PUF read operation performed to read selected SRAM bit cells 604(0)(0)-604(M)(N) to determine their natural logic state skew statistically in case the natural logic state skew is not the same for each PUF read operation, such as if the selected SRAM bit cells 604(0)(0)-604(M)(N) are weakly skewed. Then, the skew state decision circuit 650 determines the logic state skew of the accessed at least one SRAM bit cell 604(0)(0)-604(M)(N) based on the data output 624(0)-624(N) in response to the PUF read operation (block 804). The process 800 may next involve the PUF stress control circuit 606 optionally writing a reverse memory state to the accessed at least one SRAM bit cell 604(0)(0)-604(M)(N) based on the determined logic state skew of the accessed at least one SRAM bit cell 604(0)(0)-604(M)(N) before causing the stress voltage to be applied to the at least one SRAM bit cell 604(0)(0)-604(M)(N) based on the determined logic state skew (block 806). This is shown for example in FIG. 9, where the SRAM bit cell 604(0)(0) is written to be a logic ‘0’ state on its true storage output 636T(0)(0) based on a determined logic state skew of a logic ‘1’ state, and the SRAM bit cell 604(0)(N) is written to be a logic ‘1’ state on its true storage output 636T(0)(N) based on a determined logic state skew of a logic ‘0’ state. This is so that as discussed above, the logic states are stored on the true storage outputs 636T(0)(0)-636T(M)(N) and complement storage outputs 636C(0)(0)-636C(M)(N) to activate the pull-up PFETs 638P(0)(0)(1), 638P(0)(0)(2)-638P(M)(N)(1), 638P(M)(N)(2) and/or pull-down NFETs 638N(0)(0)(1), 638N(0)(0)(2)-638N(M)(N)(1), 638N(M)(N)(2) that are to be weakened with stress voltage.

With continuing reference to FIG. 8, the process 800 then involves the PUF stress control circuit 606 causing a stress voltage to be applied to the accessed at least one SRAM bit cell 604(0)(0)-604(M)(N) based on the determined logic state skew (block 808). The process 800 then involves performing a PUF read operation on SRAM bit cells 604(0)(0)-604(M)(N) in a selected SRAM bit cell row circuit 610(0)-610(M) (block 810).

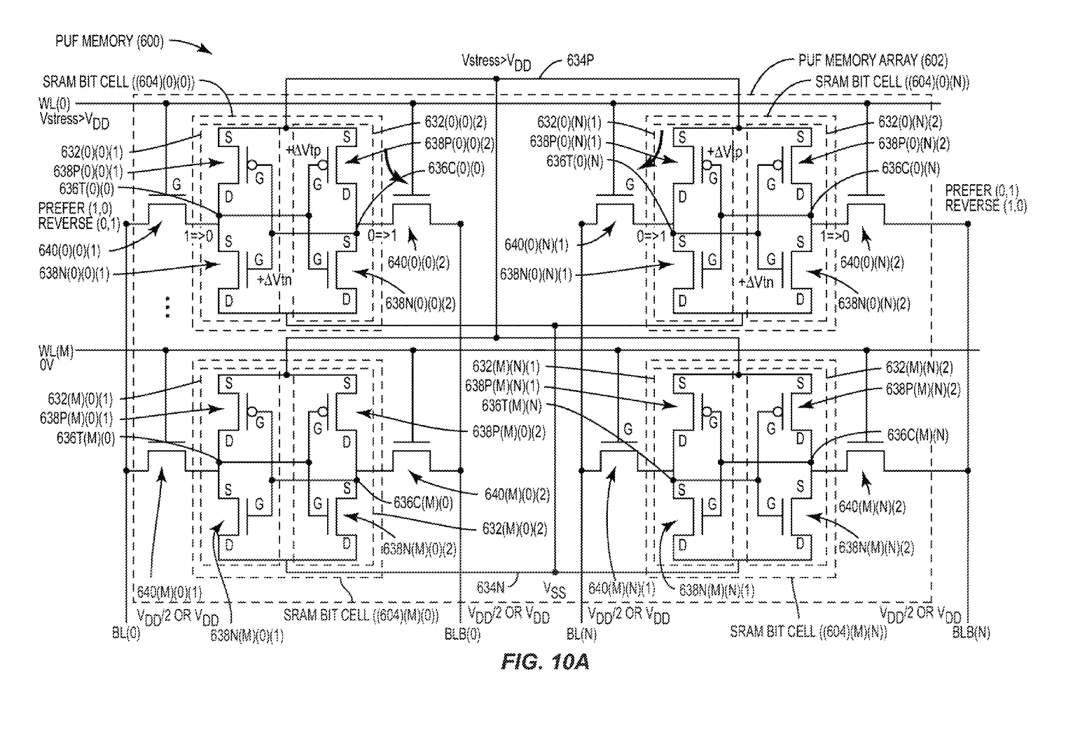

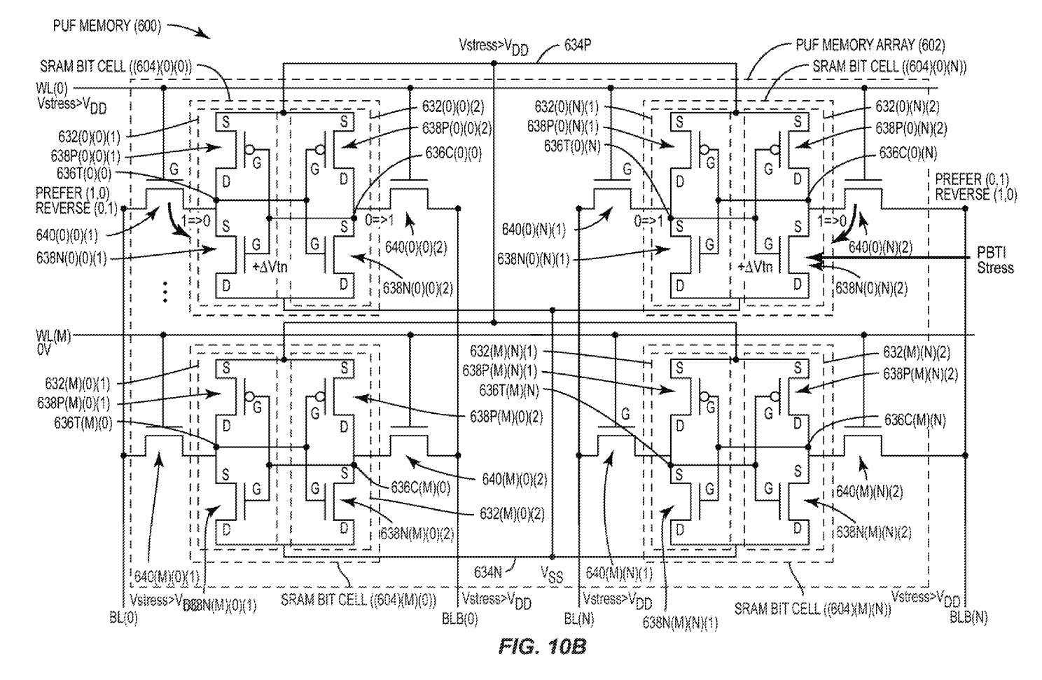

FIGS. 10A and 10B illustrate a method of applying stress voltage to SRAM bit cells 604(0)(0)-604(M)(N) in the PUF memory array 602 in FIGS. 6A and 6B. Common circuits and components between FIGS. 10A and 10B, and FIGS. 6A and 6B are shown with common element numbers, and will not be re-described.

As shown in FIG. 10A, the natural logic state skew of the SRAM bit cell 604(0)(0) is a logic ‘1’ memory state as stored in its true storage output 636T(0)(0) just as shown in FIG. 7A. To enhance the logic state skew of the SRAM bit cell 604(0)(0) in this example, the stress control circuit 652 causes the supply voltage rail stress circuit 654 to apply a stress voltage greater than the positive supply voltage V_{DD} to the positive supply voltage rail 634P like shown in FIG. 7A. The stress control circuit 652 also causes the word line stress circuit 658 to apply a stress voltage greater than the positive supply voltage V_{DD} to the word line WL(0), which also activates the NFET access transistors 640(0)(0)(1), 640(0)(0)(2) as also shown in FIG. 7A. However, in this example, the stress control circuit 652 also causes the bit line stress circuit 656 to apply a lower voltage as the positive supply voltage V_{DD} or the positive supply voltage V_{DD} divided by 2 as an example to the complement bit line BLB(0). Even applying the positive supply voltage V_{DD} to the complement bit line BLB(0) still causes a positive voltage drop from the positive supply voltage rail 634P through the pull-up PFET 638P(0)(0)(2) and the NFET access transistor 640(0)(0)(2) to the complement bit line BLB(0) to cause current to flow through the pull-up PFET 638P(0)(0)(2), because the supply voltage rail stress circuit 654 applies a stress voltage greater than the positive supply voltage V_{DD} to the positive supply voltage rail 634P. This places the pull-up PFET 638P(0)(0)(2) in an on state simulating NBTI and/or HCI stress to weaken the pull-up PFET 638P(0)(0)(2) further with respect to the pull-up PFET 638P(0)(0)(1) to enhance the natural skew logic state of the SRAM bit cell 604(0)(0) to a logic ‘1’ on its true storage output 636T(0)(0). Note that the stress control circuit 652 can also cause the bit line stress circuit 656 to apply a lower voltage as the positive supply voltage V_{DD} or the positive supply voltage V_{DD} divided by 2 as an example to the bit line BL(N) when weakening the pull-up PFET 638P(0)(N)(2).

As shown in FIG. 10B, the natural logic state skew of the SRAM bit cell 604(0)(N) is a logic ‘0’ memory state as stored in its true storage output 636T(0)(N) just as shown in FIG. 7B. To enhance the logic state skew of the SRAM bit cell 604(0)(N) in this example, the stress control circuit 652 can also cause the word line stress circuit 658 to apply a stress voltage greater than the positive supply voltage V_{DD} to the word line WL(0), which also activates the NFET access transistors 640(0)(N)(1), 640(0)(N)(2). The stress control circuit 652 also causes the bit line stress circuit 656 to apply stress voltage (e.g., V_{STRESS}) higher than the positive supply voltage V_{DD} to the bit line BL(N) and the complement bit line BLB(N). This is so that there is a positive voltage drop from the complement bit line BLB(N) through NFET access transistor 640(0)(N)(2) and the pull-down NFET 638N(0)(N)(2) to the negative supply voltage rail 634N to cause current to flow from the complement bit line BLB(N) to the negative supply voltage rail 634N. This places the pull-down NFET 638N(0)(N)(2) in an on state simulating PBTI and/or HCI stress to weaken the pull-down NFET 638N(0)(N)(2) further to enhance the natural skew logic state of the SRAM bit cell 604(0)(N) to a logic ‘1’ on its true storage output 636T(0)(N).

As discussed previously, it may be desired to determine the logic state skew of the SRAM bit cells 604(0)(0)-604(M)(N) in the PUF memory array 602 to determine how to apply voltage stress to the SRAM bit cells 604(0)(0)-604(M)(N) to further enhance their natural skew to enhance reproducibility of PUF outputs 626(0)-626(N) from the PUF memory 600 in FIG. 6A. An example, a defined number of cycles of PUF read operations can be performed on the SRAM bit cells 604(0)(0)-604(M)(N) to determine their natural logic state skews. The PUF outputs 626(0)-626(N) for accessed SRAM bit cells 604(0)(0)-604(M)(N) in the PUF read operation can be recorded and analyzed to determine the natural logic state skews of the SRAM bit cells 604(0)(0)-604(M)(N). This may take more time and/or involve additional circuits for recording and analyzing natural logic state skews of the SRAM bit cells 604(0)(0)-604(M)(N) thereby increasing complexity and power consumption in an undesired manner. As another example, the logic state skew of the SRAM bit cells 604(0)(0)-604(M)(N) in the PUF memory array 602 could be determined by employing a Bayseian probability analysis as discussed below.

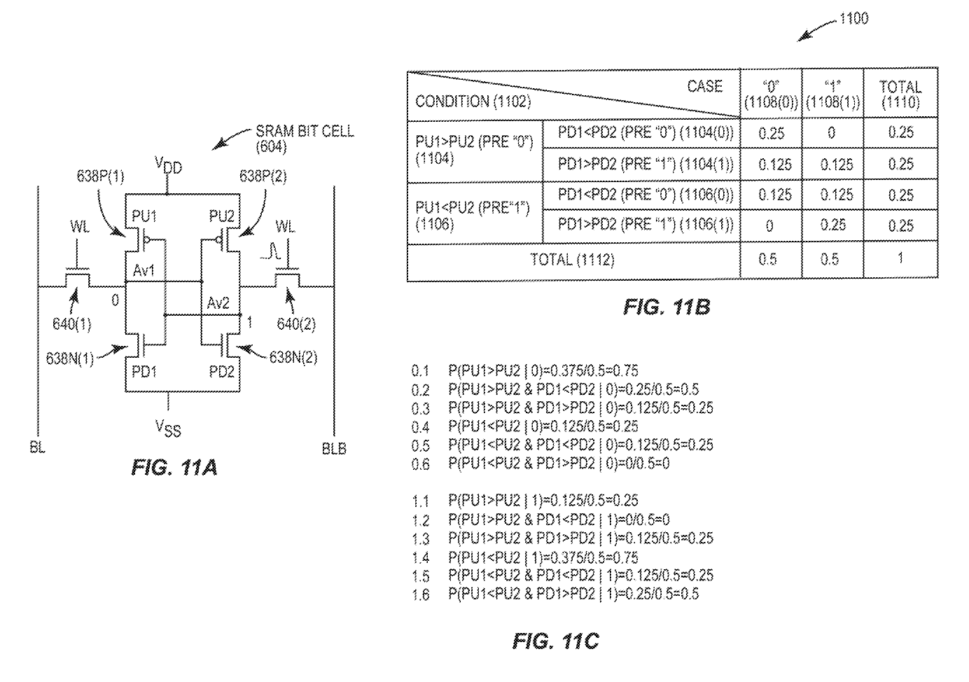

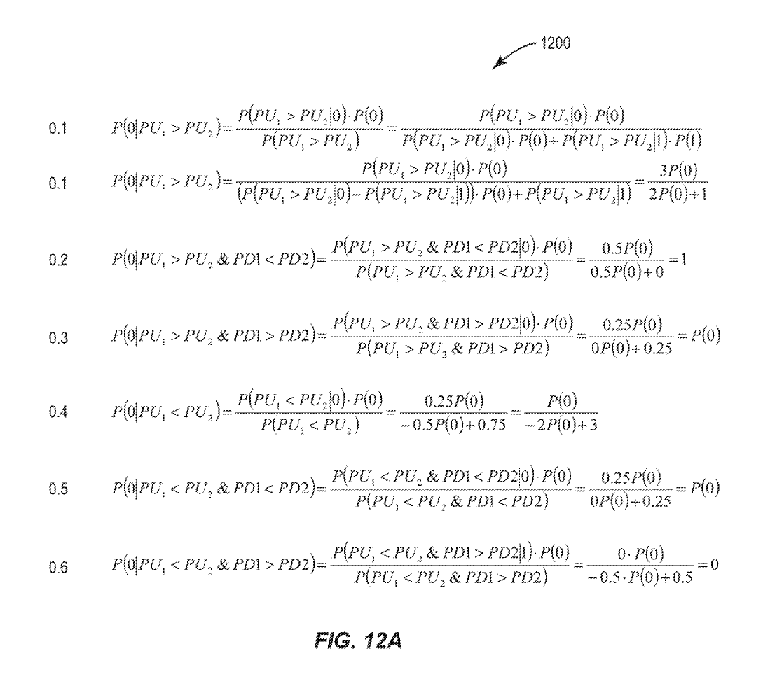

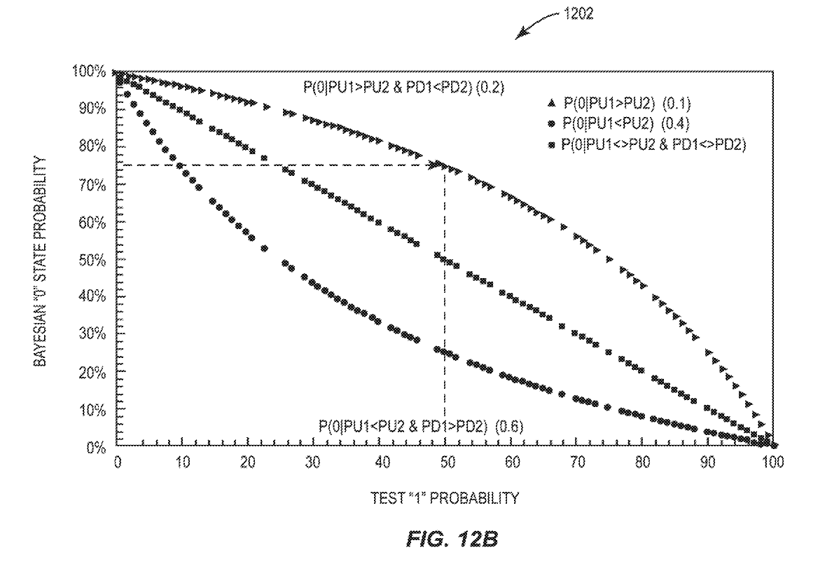

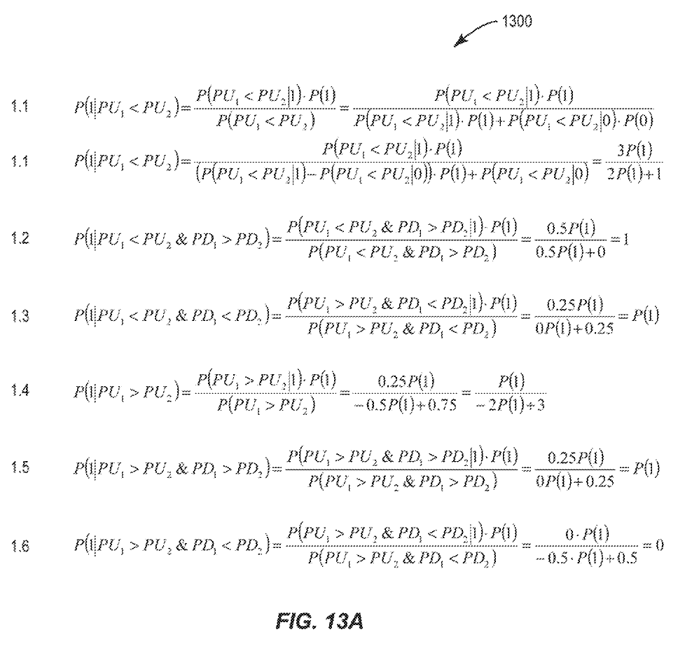

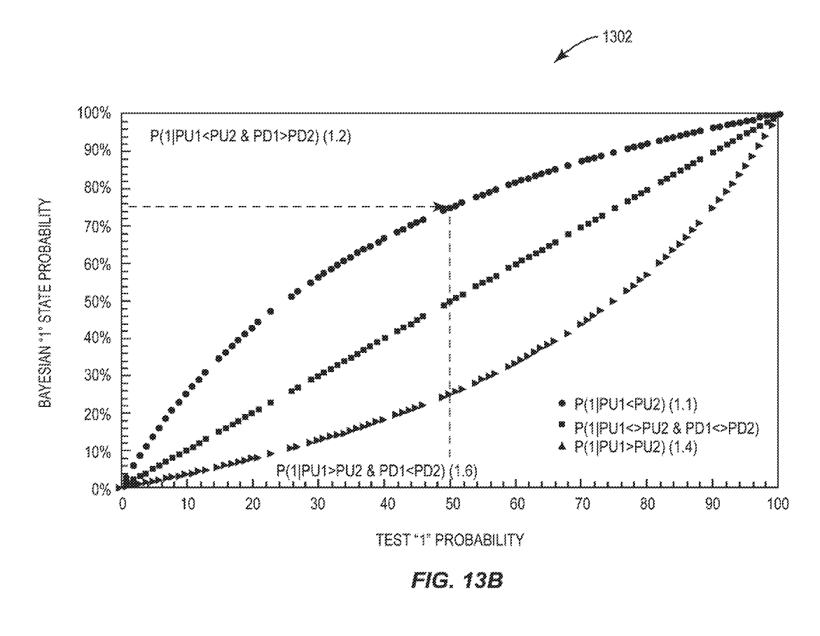

In this regard, FIG. 11A illustrates an SRAM bit cell 604 in the PUF memory array 602 in the PUF memory 600 in FIG. 6A with a logic ‘0’ stored on its true storage output 636T as its natural logic state skew. FIG. 11B is a table 1100 illustrating an exemplary likelihood probability analysis of the logic state skew stored in the SRAM bit cell 604 in FIG. 11A based on different strength comparisons between pull-up PFETs 638P(1), 638P(2) and pull-down NFETs 638N(1), 638N(2) in the SRAM bit cell 604. As shown in the table 1100, a list of possible conditions 1102 of the SRAM bit cell 604 is shown in terms of whether pull-up PFET 638P(1) (PU1) is stronger than pull-up PFET 638P(2) (PU2) 1104, or vice versa 1106. For each of these cases, the list of possible conditions 1102 of the SRAM bit cell 604 of whether pull-down NFET 638N(1) (PD1) is weaker than pull-down NFET 638N(2) (PD2) 1104(0), 1106(0), or vice versa 1104(1), 1106(1). For each case, the table 1100 includes a probability percentage for a logic state skew of ‘0’ 1108(0) or ‘1’ 1108(1), and a total probability 1110. The total probabilities 1110 added up for each logic state skew of ‘0’ 1108(0) or ‘1’ 1108(1), and total probability 1110 is shown in a total 1112 row. FIG. 11C illustrates exemplary Bayseian probability calculations of the natural logic state skew of the SRAM bit cell 604 in FIG. 11A being a logic state ‘0’ based on the likelihood probability analysis in FIG. 11B and read logic state stored in the true storage output 636T in the SRAM bit cell 604 in equations 0.1-0.6. FIG. 11C also illustrates exemplary Bayseian probability calculations of the natural logic state skew of the SRAM bit cell 604 in FIG. 11A being a logic state ‘1’ based on the likelihood probability analysis in FIG. 11B and read logic state stored in the true storage output 636T in the SRAM bit cell 604 in equations 1.1-1.6. FIG. 12A illustrates a derivation of formulas 1200 for the Bayseian probability calculations shown in FIG. 11C for a natural logic state skew of ‘0’ in the SRAM bit cell 604 in FIG. 11A. FIG. 13A illustrates a derivation of formulas 1300 for the Bayseian probability calculations shown in FIG. 11C for a natural logic state skew of ‘1’ in the SRAM bit cell 604 in FIG. 11A.

FIG. 12B is a graph 1202 illustrating a Bayseian inference probability curve for a natural logic state skew of ‘0’ based on the Bayseian probability calculations in FIGS. 11B and 12A. As shown therein, for a test probability of logic state ‘1’ below 50% for an SRAM bit cell 604, as shown in an X-axis of the graph 1202, the Bayesian probability of the logic state of the SRAM bit cell 604 having a logic state skew of ‘0’ is 75%. FIG. 13B is a graph 1302 illustrating a Bayseian inference probability curve for a natural logic state skew of ‘1’ based on the Bayseian probability calculations in FIGS. 11B and 13A. As shown therein, for a test probability of logic state ‘1’ above 50% for an SRAM bit cell 604, as shown in an X-axis of the graph 1302, the Bayesian probability of the logic state of the SRAM bit cell 604 having a logic state skew of ‘1’ is 75%.

In another exemplary aspect, a PUF stress control circuit is provided. The PUF stress circuit comprises a means for skewing coupled to a PUF output of an SRAM comprising a PUF memory array comprising one or more SRAM bit cells. The SRAM is configured to generate a data output on the PUF output based on a memory state in at least one SRAM bit cell among the one or more SRAM bit cells accessed in a read operation to the PUF memory array. The means for skewing comprises a means for receiving the data output in response to the read operation to the accessed at least one SRAM bit cell. The means for skewing also comprises a means for determining a logic state skew of the accessed at least one SRAM bit cell based on the data output. For example, the means for skewing may be the skew state decision circuit 650 in the PUF memory 600 in FIG. 6A. The PUF stress control circuit also comprises a means for stressing for causing a stress voltage to be applied to the accessed at least one SRAM bit cell based on the means for determining the logic state skew of the accessed at least one SRAM bit cell. For example, the means for stressing may be the PUF stress control circuit 606 in the PUF memory 600 in FIG. 6A. As another example, the circuits used to cause a stress voltage to be applied to the accessed at least one SRAM bit cell 604(0)(0)-604(M)(N) based on the means for determining the logic state skew of the accessed at least one SRAM bit cell 604(0)(0)-604(M)(N), under control of the means for stressing, may include any or all of the supply voltage rail stress circuit 654, the bit line stress circuit 656, and/or the word line stress circuit 658 in the PUF memory 600 in FIG. 6A.

A PUF memory employing a PUF memory array comprising one or more SRAM bit cells and a PUF stress control circuit configured to apply stress to the SRAM bit cell(s) for increased PUF output reproducibility, including but not limited to the PUF memory 600 in FIGS. 6A and 6B, as a non-limiting example, may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

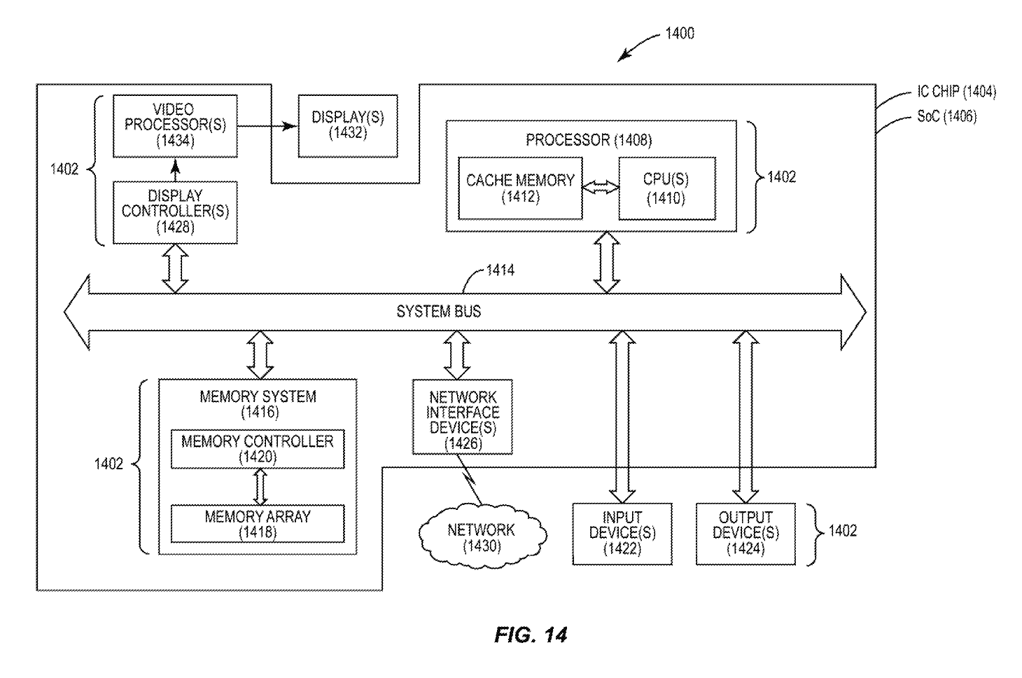

In this regard, FIG. 14 illustrates an example of a processor-based system 1400 that can include memory systems that include PUF memory 1402 employing a PUF memory array comprising one or more SRAM bit cells and a PUF stress control circuit configured to apply stress to the SRAM bit cell(s) for increased PUF output reproducibility, including but not limited to the PUF memory 600 in FIGS. 6A and 6B, as a non-limiting example. In this example, the processor-based system 700 is provided in an IC 1404. The IC 1404 may be included in or provided as a system-on-a-chip (SoC) 1406. The processor-based system 1400 includes a processor 1408 that includes one or more CPUs 1410. The processor 1408 may include a cache memory 1412 coupled to the CPU(s) 1410 for rapid access to temporarily stored data. The cache memory 1412 may include a PUF memory 1402 employing a PUF memory array comprising one or more SRAM bit cells and a PUF stress control circuit configured to apply stress to the SRAM bit cell(s) for increased PUF output reproducibility, including but not limited to the PUF memory 600 in FIGS. 6A and 6B, as a non-limiting example. The processor 1408 is coupled to a system bus 1414 and can intercouple master and slave devices included in the processor-based system 1400. As is well known, the processor 1408 communicates with these other devices by exchanging address, control, and data information over the system bus 1414. Although not illustrated in FIG. 14, multiple system buses 1414 could be provided, wherein each system bus 1414 constitutes a different fabric. For example, the processor 1408 can communicate bus transaction requests to a memory system 1416 as an example of a slave device. The memory system 1416 may include a memory array 1418 whose access is controlled by a memory controller 1420. The memory system 1416 may be or include a PUF memory 1402 employing a PUF memory array comprising one or more SRAM bit cells and a PUF stress control circuit configured to apply stress to the SRAM bit cell(s) for increased PUF output reproducibility, including but not limited to the PUF memory 600 in FIGS. 6A and 6B, as a non-limiting examples.

Other master and slave devices can be connected to the system bus 1414. As illustrated in FIG. 14, these devices can include the memory system 1416, and one or more input devices 1422, which can include a PUF memory 1402 employing a PUF memory array comprising one or more SRAM bit cells and a PUF stress control circuit configured to apply stress to the SRAM bit cell(s) for increased PUF output reproducibility, including but not limited to the PUF memory 600 in FIGS. 6A and 6B, as a non-limiting example. The input device(s) 1422 can include any type of input device, including but not limited to input keys, switches, voice processors, etc. The other devices can also include one or more output devices 1424, and one or more network interface devices 1426, both of which can include a PUF memory 1402 employing a PUF memory array comprising one or more SRAM bit cells and a PUF stress control circuit configured to apply stress to the SRAM bit cell(s) for increased PUF output reproducibility, including but not limited to the PUF memory 600 in FIGS. 6A and 6B, as a non-limiting example. The output device(s) 1424 can include any type of output device, including but not limited to audio, video, other visual indicators, etc. The other devices can also include one or more display controllers 1428 as examples. The network interface device(s) 1426 can be any devices configured to allow exchange of data to and from a network 1430. The network 1430 can be any type of network, including but not limited to a wired or wireless network, a private or public network, a local area network (LAN), a wireless local area network (WLAN), a wide area network (WAN), a BLUETOOTH™ network, and the Internet. The network interface device(s) 1426 can be configured to support any type of communications protocol desired.

The processor 1408 may also be configured to access the display controller(s) 1428 over the system bus 1414 to control information sent to one or more displays 1432. The display controller(s) 1428 sends information to the display(s) 1432 to be displayed via one or more video processors 1434, which process the information to be displayed into a format suitable for the display(s) 1432. The display controller(s) 1428 and the video processor(s) 1434 can include a PUF memory 1402 employing a PUF memory array comprising one or more SRAM bit cells and a PUF stress control circuit configured to apply stress to the SRAM bit cell(s) for increased PUF output reproducibility, including but not limited to the PUF memory 600 in FIGS. 6A and 6B, as a non-limiting example. The display(s) 1432 can include any type of display, including but not limited to a cathode ray tube (CRT), a liquid crystal display (LCD), a plasma display, etc.

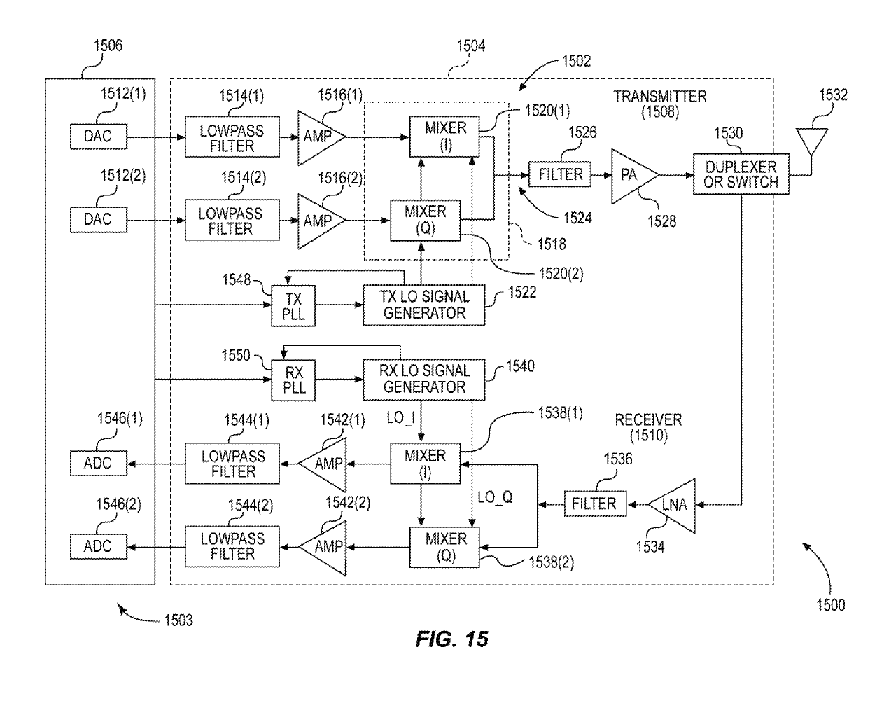

FIG. 15 illustrates an exemplary wireless communications device 1500 that includes radio frequency (RF) components formed in an integrated circuit (IC) 1502, wherein any of the components therein can include PUF memory 1503 employing a PUF memory array comprising one or more SRAM bit cells and a PUF stress control circuit configured to apply stress to the SRAM bit cell(s) for increased PUF output reproducibility, including but not limited to the PUF memory 600 in FIGS. 6A and 6B, as a non-limiting example. In this regard, the wireless communications device 1500 may be provided in the IC 1502. The wireless communications device 1500 may include or be provided in any of the above referenced devices, as examples. As shown in FIG. 15, the wireless communications device 1500 includes a transceiver 1504 and a data processor 1506. The data processor 1506 may include a memory to store data and program codes. The transceiver 1504 includes a transmitter 1508 and a receiver 1510 that support bi-directional communications. In general, the wireless communications device 1500 may include any number of transmitters 1508 and/or receivers 1510 for any number of communication systems and frequency bands. All or a portion of the transceiver 1504 may be implemented on one or more analog ICs, RF ICs (RFICs), mixed-signal ICs, etc.

The transmitter 1508 or the receiver 1510 may be implemented with a super-heterodyne architecture or a direct-conversion architecture. In the super-heterodyne architecture, a signal is frequency-converted between RF and baseband in multiple stages, e.g., from RF to an intermediate frequency (IF) in one stage, and then from IF to baseband in another stage for the receiver 1510. In the direct-conversion architecture, a signal is frequency-converted between RF and baseband in one stage. The super-heterodyne and direct-conversion architectures may use different circuit blocks and/or have different requirements. In the wireless communications device 1500 in FIG. 15, the transmitter 1508 and the receiver 1510 are implemented with the direct-conversion architecture.

In the transmit path, the data processor 1506 processes data to be transmitted and provides I and Q analog output signals to the transmitter 1508. In the exemplary wireless communications device 1500, the data processor 1506 includes digital-to-analog converters (DACs) 1512(1), 1512(2) for converting digital signals generated by the data processor 1506 into the I and Q analog output signals, e.g., I and Q output currents, for further processing.

Within the transmitter 1508, lowpass filters 1514(1), 1514(2) filter the I and Q analog output signals, respectively, to remove undesired signals caused by the prior digital-to-analog conversion. Amplifiers (AMP) 1516(1), 1516(2) amplify the signals from the lowpass filters 1514(1), 1514(2), respectively, and provide I and Q baseband signals. An upconverter 1518 upconverts the I and Q baseband signals with I and Q transmit (TX) local oscillator (LO) signals through mixers 1520(1), 1520(2) from a TX LO signal generator 1522 to provide an upconverted signal 1524. A filter 1526 filters the upconverted signal 1524 to remove undesired signals caused by the frequency upconversion as well as noise in a receive frequency band. A power amplifier (PA) 1528 amplifies the upconverted signal 1524 from the filter 1526 to obtain the desired output power level and provides a transmit RF signal. The transmit RF signal is routed through a duplexer or switch 1530 and transmitted via an antenna 1532.

In the receive path, the antenna 1532 receives signals transmitted by base stations and provides a received RF signal, which is routed through the duplexer or switch 1530 and provided to a low noise amplifier (LNA) 1534. The duplexer or switch 1530 is designed to operate with a specific receive (RX)-to-TX duplexer frequency separation, such that RX signals are isolated from TX signals. The received RF signal is amplified by the LNA 1534 and filtered by a filter 1536 to obtain a desired RF input signal. Downconversion mixers 1538(1), 1538(2) mix the output of the filter 1536 with I and Q RX LO signals (i.e., LO_I and LO_Q) from an RX LO signal generator 1540 to generate I and Q baseband signals. The I and Q baseband signals are amplified by amplifiers (AMP) 1542(1), 1542(2) and further filtered by lowpass filters 1544(1), 1544(2) to obtain I and Q analog input signals, which are provided to the data processor 1506. In this example, the data processor 1506 includes ADCs 1546(1), 1546(2) for converting the analog input signals into digital signals to be further processed by the data processor 1506.

In the wireless communications device 1500 of FIG. 15, the TX LO signal generator 1522 generates the I and Q TX LO signals used for frequency upconversion, while the RX LO signal generator 1540 generates the I and Q RX LO signals used for frequency downconversion. Each LO signal is a periodic signal with a particular fundamental frequency. A TX phase-locked loop (PLL) circuit 1548 receives timing information from the data processor 1506 and generates a control signal used to adjust the frequency and/or phase of the TX LO signals from the TX LO signal generator 1522. Similarly, an RX PLL circuit 1550 receives timing information from the data processor 1506 and generates a control signal used to adjust the frequency and/or phase of the RX LO signals from the RX LO signal generator 1540.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The master devices and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A physically unclonable function (PUF) stress control circuit, comprising:
a skew state decision circuit coupled to a PUF output of a static random access memory (SRAM) comprising a PUF memory array comprising one or more SRAM bit cells, the SRAM configured to generate a data output on the PUF output based on a memory state in at least one SRAM bit cell among the one or more SRAM bit cells accessed in a read operation to the PUF memory array;
the skew state decision circuit configured to:
receive the data output in response to the read operation to the accessed at least one SRAM bit cell in the PUF memory array; and
determine a logic state skew of the accessed at least one SRAM bit cell based on the data output; and
a stress control circuit coupled to the PUF memory array and the skew state decision circuit, the stress control circuit configured to cause a stress voltage to be applied to the accessed at least one SRAM bit cell based on the determined logic state skew.

2. The PUF stress control circuit of claim 1, wherein each of the one or more SRAM bit cells comprises:
a first inverter comprising a first pull-up transistor configured to be coupled to a positive supply voltage rail configured to receive a supply voltage and a first pull-down transistor configured to be coupled to a negative supply voltage rail; and
a second inverter comprising a second pull-up transistor configured to be coupled to the positive supply voltage rail and a second pull-down transistor configured to be coupled to the negative supply voltage rail;
the first inverter comprising a first input coupled to gates of the first pull-up transistor and the first pull-down transistor, and a true storage output coupled to the first pull-up transistor and the first pull-down transistor, the true storage output configured to store a true logic state; and
the first inverter comprising a second input coupled to gates of the second pull-up transistor and the second pull-down transistor, and a complement storage output coupled to the second pull-up transistor and the second pull-down transistor, the complement storage output configured to store a complement logic state complementary to the true logic state.

3. The PUF stress control circuit of claim 2, wherein the stress control circuit is configured to cause the stress voltage to be applied to the second pull-up transistor and the first pull-down transistor of the at least one SRAM bit cell based on the determined logic state skew of the at least one SRAM bit cell being a logic state ‘0’ on the true storage output.

4. The PUF stress control circuit of claim 3, wherein the stress control circuit is configured to cause the stress voltage to be applied to the second pull-up transistor and the first pull-down transistor, by causing a positively boosted voltage above the supply voltage to be applied to the positive supply voltage rail coupled to the second pull-up transistor and the first pull-down transistor.

5. The PUF stress control circuit of claim 2, wherein the stress control circuit is configured to cause the stress voltage to be applied to the first pull-up transistor and the second pull-down transistor of the at least one SRAM bit cell based on the determined logic state skew of the at least one SRAM bit cell being a logic state ‘1’ on the true storage output.

6. The PUF stress control circuit of claim 5, wherein the stress control circuit is configured to cause the stress voltage to be applied to the first pull-up transistor and the second pull-down transistor, by causing a positively boosted voltage above the supply voltage to be applied to the positive supply voltage rail coupled to the first pull-up transistor and the second pull-down transistor.

7. The PUF stress control circuit of claim 2, wherein each of the one or more SRAM bit cells further comprises:
a first access transistor comprising a gate coupled to a word line, a source or a drain coupled to a bit line, and a drain or a source coupled to the true storage output; and
a second access transistor comprising a gate coupled to the word line, a source or a drain coupled to a complement bit line, and a drain or a source coupled to the complement storage output.

8. The PUF stress control circuit of claim 7, wherein the stress control circuit is configured to cause the stress voltage to be applied to the second pull-up transistor of the at least one SRAM bit cell based on the determined logic state skew of the at least one SRAM bit cell being a logic state ‘0’ on the true storage output, by being configured to:
cause a voltage to be applied to the complement bit line lower than a positive supply voltage;
cause a positively boosted voltage above the supply voltage to be applied to the word line to be applied to the gate of the second access transistor to activate the second access transistor; and
cause a positively boosted voltage above the supply voltage to be applied to the positive supply voltage rail coupled to the second pull-up transistor.

9. The PUF stress control circuit of claim 8, wherein the stress control circuit is configured to cause the voltage to be applied to the complement bit line lower than the positive supply voltage, by being configured to cause the voltage to be applied to the complement bit line of the positive supply voltage.

10. The PUF stress control circuit of claim 8, wherein the stress control circuit is configured to cause the voltage to be applied to the complement bit line lower than the positive supply voltage, by being configured to cause the voltage to be applied to the complement bit line of approximately half of the positive supply voltage.

11. The PUF stress control circuit of claim 7, wherein the stress control circuit is configured to cause the stress voltage to be applied to the first pull-down transistor of the at least one SRAM bit cell based on the determined logic state skew of the at least one SRAM bit cell being a logic state ‘0’ on the true storage output, by being configured to:
cause a positively boosted voltage above the supply voltage to be applied to the bit line; and
cause a positively boosted voltage above the supply voltage to be applied to the word line to be applied to the gate of the first access transistor to activate the first access transistor.

12. The PUF stress control circuit of claim 7, wherein the stress control circuit is configured to cause the stress voltage to be applied to the first pull-down transistor of the at least one SRAM bit cell based on the determined logic state skew of the at least one SRAM bit cell being a logic state ‘0’ on the true storage output, by being configured to:
cause a negative supply voltage to be applied to the bit line; and
cause a positively boosted voltage above the supply voltage to be applied to the word line to be applied to the gate of the first access transistor to activate the first access transistor.

13. The PUF stress control circuit of claim 7, wherein the stress control circuit is configured to cause the stress voltage to be applied to the first pull-up transistor of the at least one SRAM bit cell based on the determined logic state skew of the at least one SRAM bit cell being a logic state ‘1’ on the true storage output, by being configured to:
cause a voltage to be applied to the bit line lower than a positive supply voltage;
cause a positively boosted voltage above the supply voltage to be applied to the word line to be applied to the gate of the first access transistor to activate the first access transistor; and
cause a positively boosted voltage above the supply voltage to be applied to the positive supply voltage rail coupled to the first pull-up transistor.

14. The PUF stress control circuit of claim 13, wherein the stress control circuit is configured to cause the voltage to be applied to the bit line lower than the positive supply voltage, by being configured to cause the voltage to be applied to the bit line of the positive supply voltage.

15. The PUF stress control circuit of claim 13, wherein the stress control circuit is configured to cause the voltage to be applied to the bit line lower than the positive supply voltage, by being configured to cause the voltage to be applied to the bit line of approximately half of the positive supply voltage.

16. The PUF stress control circuit of claim 7, wherein the stress control circuit is configured to cause the stress voltage to be applied to the second pull-down transistor of the at least one SRAM bit cell based on the determined logic state skew of the at least one SRAM bit cell being a logic state ‘1’ on the true storage output, by being configured to:
cause a positively boosted voltage above the supply voltage to be applied to the complement bit line; and
cause a positively boosted voltage above the supply voltage to be applied to the word line to be applied to the gate of the second access transistor to activate the second access transistor.

17. The PUF stress control circuit of claim 7, wherein the stress control circuit is configured to cause the stress voltage to be applied to the second pull-down transistor of the at least one SRAM bit cell based on the determined logic state skew of the at least one SRAM bit cell being a logic state ‘1’ on the true storage output, by being configured to:
cause a positively boosted voltage above the supply voltage to be applied to the complement bit line; and
cause a positively boosted voltage above the supply voltage to be applied to the word line to be applied to the gate of the second access transistor to activate the second access transistor.

18. The PUF stress control circuit of claim 1, wherein:
the one or more SRAM bit cells are coupled to a positive supply voltage rail configured to receive a positive supply voltage; and
further comprising a supply voltage rail stress circuit coupled to the positive supply voltage rail and the stress control circuit, the stress control circuit configured to cause the supply voltage rail stress circuit to apply the stress voltage to the at least one SRAM bit cell based on the determined logic state skew, by being configured to cause the supply voltage rail stress circuit to apply a positively boosted voltage above a positive supply voltage to the positive supply voltage rail.

19. The PUF stress control circuit of claim 1, wherein:
the one or more SRAM bit cells are coupled to a bit line and a complement bit line; and
further comprising a bit line stress circuit coupled to the stress control circuit, the stress control circuit configured to cause the bit line stress circuit to apply the stress voltage to the at least one SRAM bit cell based on the determined logic state skew, by being configured to cause the bit line stress circuit to apply a voltage below a positive supply voltage to the bit line and the complement bit line.

20. The PUF stress control circuit of claim 1, wherein:
the one or more SRAM bit cells are coupled to a bit line and a complement bit line; and
further comprising a bit line stress circuit coupled to the stress control circuit, the stress control circuit configured to cause the bit line stress circuit to apply the stress voltage to the at least one SRAM bit cell based on the determined logic state skew, by being configured to cause the bit line stress circuit to apply a voltage above a positive supply voltage to the bit line and the complement bit line.

21. The PUF stress control circuit of claim 1, wherein:
the one or more SRAM bit cells are coupled to a word line; and
further comprising a word line stress circuit coupled to the stress control circuit, the stress control circuit configured to cause the word line stress circuit to apply a voltage above a positive supply voltage to the word line.

22. The PUF stress control circuit of claim 1 integrated into an integrated circuit (IC).

23. The PUF stress control circuit of claim 1 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

24. A physically unclonable function (PUF) stress control circuit, comprising:
a means for skewing coupled to a PUF output of a static random access memory (SRAM) comprising a PUF memory array comprising one or more SRAM bit cells, the SRAM configured to generate a data output on the PUF output based on a memory state in at least one SRAM bit cell among the one or more SRAM bit cells accessed in a read operation to the PUF memory array;
the means for skewing comprising:
a means for receiving the data output in response to the read operation to the accessed at least one SRAM bit cell in the PUF memory array; and
a means for determining a logic state skew of the accessed at least one SRAM bit cell based on the data output; and
a means for stressing for causing a stress voltage to be applied to the accessed at least one SRAM bit cell based on the means for determining the logic state skew of the accessed at least one SRAM bit cell.

25. A method of applying a stress to one or more static random access memory (SRAM) bit cells in a physically unclonable function (PUF) array, comprising:
initiating a configuration read operation of a PUF memory array comprising one or more SRAM bit cells to receive a data output from a PUF output based on a memory state in at least one SRAM bit cell among the one or more SRAM bit cells accessed in the configuration read operation;
determining a logic state skew of the accessed at least one SRAM bit cell based on the data output; and
causing a stress voltage to be applied to the accessed at least one SRAM bit cell based on the determined logic state skew.

26. The method of claim 25, further comprising writing the memory state to the accessed at least one SRAM bit cell based on the determined logic state skew of the accessed at least one SRAM bit cell before causing the stress voltage to be applied to the at least one SRAM bit cell based on the determined logic state skew.

27. The method of claim 25, further comprising performing a read operation to at least one SRAM bit cell among the one or more SRAM bit cells after causing the stress voltage to be applied to the at least one SRAM bit cell based on the determined logic state skew.

28. The method of claim 25, further comprising:
repeatedly initiating the configuration read operation and determining the logic state skew of the accessed at least one SRAM bit cell for a defined number of cycles before causing the stress voltage to be applied to the at least one SRAM bit cell based on the determined logic state skew;
determining a logic state skew of the accessed at least one SRAM bit cell based on the data output based on the repeated initiation of the configuration read operation and determining the logic state skew of the accessed at least one SRAM bit cell for the defined number of cycles; and
causing the stress voltage to be applied to the at least one SRAM bit cell based on the determined logic state skew.

29. The method of claim 25, wherein each of the one or more SRAM bit cells comprises:
a first inverter comprising a first pull-up transistor configured to be coupled to a positive supply voltage rail configured to receive a supply voltage and a first pull-down transistor configured to be coupled to a negative supply voltage rail; and
a second inverter comprising a second pull-up transistor configured to be coupled to the positive supply voltage rail and a second pull-down transistor configured to be coupled to the negative supply voltage rail;
the first inverter comprising a first input coupled to gates of the first pull-up transistor and the first pull-down transistor and a true storage output coupled to the first pull-up transistor and the first pull-down transistor, the true storage output configured to store a first logic state; and
the first inverter comprising a second input coupled to the gates of the second pull-up transistor and the second pull-down transistor and a complement storage output coupled to the second pull-up transistor and the second pull-down transistor, the complement storage output configured to store a second logic state complementary to the first logic state.

30. The method of claim 29, wherein, in response to the determined logic state skew of the at least one SRAM bit cell being a logic state ‘0’ on the true storage output, causing the stress voltage to be applied comprises causing the stress voltage to be applied to the second pull-up transistor and the first pull-down transistor of the accessed at least one SRAM bit cell.

31. The method of claim 29, wherein, in response to the determined logic state skew of the at least one SRAM bit cell being a logic state ‘1’ on the true storage output, causing the stress voltage to be applied comprises causing the stress voltage to be applied to the first pull-up transistor and the second pull-down transistor of the accessed at least one SRAM bit cell.

32. A physically unclonable function (PUF) memory, comprising:
a PUF memory array, comprising:
a plurality of PUF bit cell row circuits each comprising a plurality of static random access memory (SRAM) bit cells; and
a plurality of PUF bit cell column circuits each comprising an SRAM bit cell among the plurality of SRAM bit cells from an SRAM bit cell row circuit among the plurality of SRAM bit cell row circuits; and
a PUF output coupled to the PUF memory array;
the PUF memory configured to generate a data output on the PUF output based on a memory state in at least one SRAM bit cell among the plurality of SRAM bit cells accessed in a read operation to the PUF memory array; and
further comprising:
a PUF stress control circuit configured to:
receive the data output in response to the read operation to the accessed at least one SRAM bit cell in the PUF memory array;
determine a logic state skew of the accessed at least one SRAM bit cell based on the data output; and
cause a stress voltage to be applied to the accessed at least one SRAM bit cell based on the determined logic state skew.

33. The PUF memory of claim 32, further comprising:
a positive supply voltage rail configured to receive a positive supply voltage, the positive supply voltage rail coupled to each of the plurality of SRAM bit cells in the PUF memory array;
a negative supply voltage rail configured to receive a negative supply voltage, the negative supply voltage rail coupled to each of the plurality of SRAM bit cells in the PUF memory array;
a plurality of word lines, each word line among the plurality of word lines coupled to a PUF bit cell row circuit among the plurality of PUF bit cell row circuits each comprising the plurality of SRAM bit cells;
a plurality of bit lines, each bit line among the plurality of bit lines coupled to a PUF bit cell column circuit among the plurality of PUF bit cell column circuits; and
a plurality of complement bit lines, each complement bit line among the plurality of complement bit lines coupled to a PUF bit cell column circuit among the plurality of PUF bit cell column circuits.

34. The PUF memory of claim 33, wherein the PUF stress control circuit is configured to cause the stress voltage to be applied to the accessed at least one SRAM bit cell based on the determined logic state skew, by being configured to cause a positively boosted voltage above the positive supply voltage to be applied to the positive supply voltage rail.

35. The PUF memory of claim 33, wherein the PUF stress control circuit is configured to cause the stress voltage to be applied to the accessed at least one SRAM bit cell based on the determined logic state skew, by being configured to cause a voltage below the positive supply voltage to be applied to the bit line and the complement bit line coupled to the PUF bit cell column circuit of the accessed at least one SRAM bit cell.

36. The PUF memory of claim 33, wherein the PUF stress control circuit is configured to cause the stress voltage to be applied to the accessed at least one SRAM bit cell based on the determined logic state skew, by being configured to cause a voltage above the positive supply voltage to be applied to the bit line and the complement bit line coupled to the PUF bit cell column circuit of the accessed at least one SRAM bit cell.

37. The PUF memory of claim 33, wherein the PUF stress control circuit is configured to cause the stress voltage to be applied to the accessed at least one SRAM bit cell based on the determined logic state skew, by being configured to cause a voltage above the positive supply voltage to be applied to the word line coupled to the PUF bit cell row circuit of the accessed at least one SRAM bit cell.

38. The PUF memory of claim 33, wherein each of the plurality of SRAM bit cells comprises:
a first inverter comprising a first pull-up transistor configured to be coupled to the positive supply voltage rail configured to receive a supply voltage and a first pull-down transistor configured to be coupled to the negative supply voltage rail; and
a second inverter comprising a second pull-up transistor configured to be coupled to the positive supply voltage rail and a second pull-down transistor configured to be coupled to the negative supply voltage rail;
the first inverter comprising a first input coupled to gates of the first pull-up transistor and the first pull-down transistor, and a true storage output coupled to the first pull-up transistor and the first pull-down transistor, the true storage output configured to store a true logic state; and
the first inverter comprising a second input coupled to gates of the second pull-up transistor and the second pull-down transistor, and a complement storage output coupled to the second pull-up transistor and the second pull-down transistor, the complement storage output configured to store a complement logic state complementary to the true logic state.

39. The PUF memory of claim 38, wherein, in response to the determined logic state skew of the at least one SRAM bit cell being a logic state ‘0’ on the true storage output, the PUF stress control circuit is configured to cause the stress voltage to be applied by being configured to cause the stress voltage to be applied to the second pull-up transistor and the first pull-down transistor of the accessed at least one SRAM bit cell.

40. The PUF memory of claim 38, wherein, in response to the determined logic state skew of the at least one SRAM bit cell being a logic state ‘1’ on the true storage output, the PUF stress control circuit is configured to cause the stress voltage to be applied by being configured to cause the stress voltage to be applied to the first pull-up transistor and the second pull-down transistor of the accessed at least one SRAM bit cell.

41. The PUF memory of claim 38, wherein each of the plurality of SRAM bit cells further comprises:
a first access transistor comprising a gate coupled to a word line, a source or a drain coupled to a bit line, and a drain or a source coupled to the true storage output; and
a second access transistor comprising a gate coupled to the word line, a source or a drain coupled to a complement bit line, and a drain or a source coupled to the complement storage output.

42. The PUF memory of claim 41, wherein:
in response to the determined logic state skew of the at least one SRAM bit cell being a logic state ‘0’ on the true storage output, the PUF stress control circuit is configured to:
cause a voltage to be applied to the complement bit line lower than the positive supply voltage;
cause a positively boosted voltage above the supply voltage to be applied to the word line to be applied to the gate of the second access transistor to activate the second access transistor;
cause a positively boosted voltage above the supply voltage to be applied to the positive supply voltage rail coupled to the second pull-up transistor;
cause a positively boosted voltage above the supply voltage to be applied to the bit line; and
cause a positively boosted voltage above the supply voltage to be applied to the word line to be applied to the gate of the first access transistor to activate the first access transistor.

43. The PUF memory of claim 41, wherein:
in response to the determined logic state skew of the at least one SRAM bit cell being a logic state ‘1’ on the true storage output, the PUF stress control circuit is configured to:
cause a voltage to be applied to the bit line lower than the positive supply voltage;
cause a positively boosted voltage above the supply voltage to be applied to the word line to be applied to the gate of the first access transistor to activate the first access transistor;
cause a positively boosted voltage above the supply voltage to be applied to the positive supply voltage rail coupled to the first pull-up transistor;
cause a positively boosted voltage above the supply voltage to be applied to the complement bit line; and
cause a positively boosted voltage above the supply voltage to be applied to the word line to be applied to the gate of the second access transistor to activate the second access transistor.
